(19) United States
(12) Patent Application Publication
(10) Pub. No.: US 2025/0167852 A1
(43) Pub. Date: May 22, 2025

(54) TIME DOMAIN BEAM PREDICTION USING CHANNEL STATE INFORMATION REPORTING

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 18/841,891

(22) PCT Filed: Apr. 13, 2022
(86) PCT No.: PCT/CN2022/086589

§ 371 Date: Aug. 27, 2024

(51) Int. Cl. H04B 7/06; H04B 17/318; H04W 24/10

(52) U.S. Cl. CPC H04B 7/0626; H04B 17/328; H04W 24/10

(57) ABSTRACT

Various aspects of the present disclosure generally relate to wireless communication. In some aspects, a user equipment (UE) may transmit, to a network node, a periodic or semi-persistent (P/SP) channel state information (CSI) report that indicates a layer 1 (L1) reference signal received power (RSRP) or signal-to-interference-plus-noise ratio (SINR) (L1-RSRP/SINR) measurement for each of a set of channel measurement resources (CMRs). The UE may receive, from the network node, a request for an aperiodic (AP) CSI report. The UE may transmit, to the network node, the AP CSI report based at least in part on the request, wherein the AP CSI report indicates L1-RSRP/SINR measurements of K CMRs. Numerous other aspects are described.

### FIELD OF THE DISCLOSURE

Aspects of the present disclosure generally relate to wireless communication and to techniques and apparatuses for time domain beam prediction using channel state information (CSI) reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: transmit, to a network node, a periodic or semi-persistent (P/SP) channel state information (CSI) report that indicates a layer 1 (L1) reference signal received power (RSRP) or signal-to-interference-plus-noise ratio (SINR) (L1-RSRP/SINR) measurement for each of a set of channel measurement resources (CMRs); receive, from the network node, a request for an aperiodic (AP) CSI report; and transmit, to the network node, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report.

In some implementations, an apparatus for wireless communication at a network node includes a memory and one or more processors, coupled to the memory, configured to: receive, from a UE, a P/SP CSI report that indicates an L1-RSRP/SINR measurement for each of a set of CMRs; transmit, to the UE, a request for an AP CSI report; and receive, from the UE, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report.

In some implementations, an apparatus for wireless communication at a UE includes a memory and one or more processors, coupled to the memory, configured to: receive, from a network node, a CSI report configuration; and transmit, to the network node and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs, wherein a time domain beam prediction is based at least in part on the CSI report.

In some implementations, an apparatus for wireless communication at a network node includes a memory and one or more processors, coupled to the memory, configured to: transmit, to a UE, a CSI report configuration; receive, from the UE and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs; and perform a time domain beam prediction based at least in part the CSI report.

In some implementations, a method of wireless communication performed by a UE includes transmitting, to a network node, a P/SP CSI report that indicates an L1-RSRP/SINR measurement for each of a set of CMRs; receiving, from the network node, a request for an AP CSI report; and transmitting, to the network node, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report.

In some implementations, a method of wireless communication performed by a network node includes receiving, from a UE, a P/SP CSI report that indicates an L1-RSRP/SINR measurement for each of a set of CMRs; transmitting, to the UE, a request for an AP CSI report; and receiving, from the UE, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report.

In some implementations, a method of wireless communication performed by a UE includes receiving, from a network node, a CSI report configuration; and transmitting, to the network node and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs, wherein a time domain beam prediction is based at least in part on the CSI report.

In some implementations, a method of wireless communication performed by a network node includes transmitting, to a UE, a CSI report configuration; receiving, from the UE and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs; and performing a time domain beam prediction based at least in part the CSI report.

In some implementations, a non-transitory computer-readable medium storing a set of instructions for wireless communication includes one or more instructions that, when executed by one or more processors of a UE, cause the UE to: transmit, to a network node, a P/SP CSI report that indicates an L1-RSRP/SINR measurement for each of a set of CMRs; receive, from the network node, a request for an AP CSI report; and transmit, to the network node, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report.

In some implementations, a non-transitory computer-readable medium storing a set of instructions for wireless communication includes one or more instructions that, when executed by one or more processors of a network node, cause the network node to: receive, from a UE, a P/SP CSI report that indicates an L1-RSRP/SINR measurement for each of a set of CMRs; transmit, to the UE, a request for an AP CSI report; and receive, from the UE, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report.

In some implementations, a non-transitory computer-readable medium storing a set of instructions for wireless communication includes one or more instructions that, when executed by one or more processors of a UE, cause the UE to: receive, from a network node, a CSI report configuration; and transmit, to the network node and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs, wherein a time domain beam prediction is based at least in part on the CSI report.

In some implementations, a non-transitory computer-readable medium storing a set of instructions for wireless communication includes one or more instructions that, when executed by one or more processors of a network node, cause the network node to: transmit, to a UE, a CSI report configuration; receive, from the UE and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs; and perform a time domain beam prediction based at least in part the CSI report.

In some implementations, an apparatus for wireless communication includes means for transmitting, to a network node, a P/SP CSI report that indicates an L1-RSRP/SINR measurement for each of a set of CMRs; means for receiving, from the network node, a request for an AP CSI report; and means for transmitting, to the network node, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report.

In some implementations, an apparatus for wireless communication includes means for receiving, from a UE, a P/SP CSI report that indicates an L1-RSRP/SINR measurement for each of a set of CMRs; means for transmitting, to the UE, a request for an AP CSI report; and means for receiving, from the UE, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report.

In some implementations, an apparatus for wireless communication includes means for receiving, from a network node, a CSI report configuration; and means for transmitting, to the network node and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs, wherein a time domain beam prediction is based at least in part on the CSI report.

In some implementations, an apparatus for wireless communication includes means for transmitting, to a UE, a CSI report configuration; means for receiving, from the UE and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs; and means for performing a time domain beam prediction based at least in part the CSI report.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating examples of beam management procedures, in accordance with the present disclosure.

FIG. 5 is a diagram illustrating an example of wireless communications, in accordance with the present disclosure.

FIG. 6 is a diagram illustrating an example of a time domain beam prediction, in accordance with the present disclosure.

FIGS. 7-8 are diagrams illustrating examples associated with time domain beam prediction using channel state information (CSI) reporting, in accordance with the present disclosure.

FIGS. 9-12 are diagrams illustrating examples associated with CSI reporting, in accordance with the present disclosure.

FIGS. 13-16 are diagrams illustrating example processes associated with time domain beam prediction using CSI reporting, in accordance with the present disclosure.

FIGS. 17-18 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

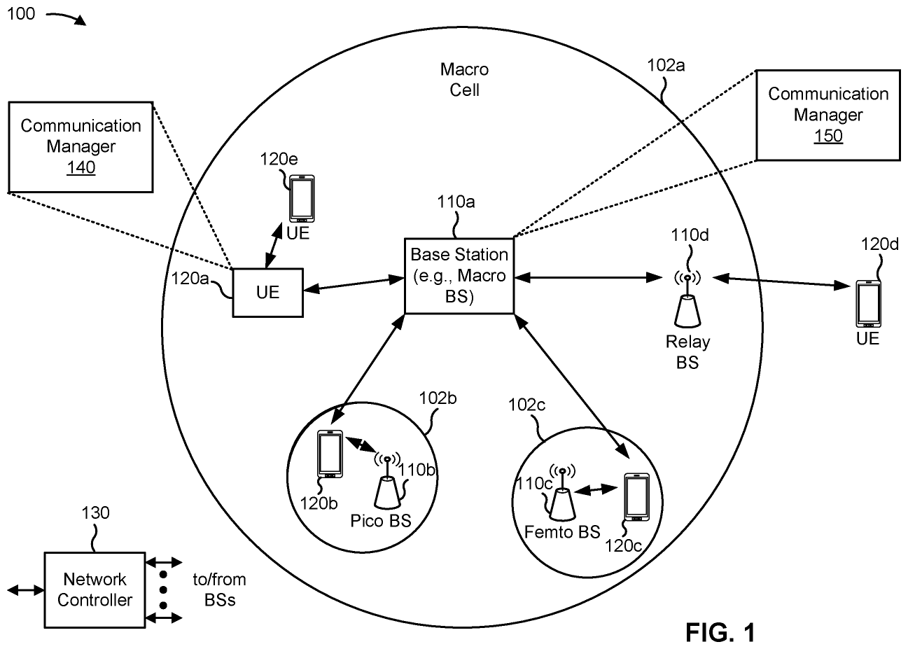

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network node” may refer to an aggregated base station, a disaggregated base station, an integrated access and backhaul (IAB) node, a relay node, and/or one or more components thereof. For example, in some aspects, “base station” or “network node” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the base station 110. In some aspects, the term “base station” or “network node” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations and/or one or more virtual base station functions. For example, in some aspects, two or more base station functions may be instantiated on a single device. In some aspects, the term “base station” or “network node” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may transmit, to a network node, a periodic or semi-persistent (P/SP) channel state information (CSI) report that indicates a layer 1 (L1) reference signal received power (RSRP) or signal-to-interference-plus-noise ratio (SINR) (L1-RSRP/SINR) measurement for each of a set of channel measurement resources (CMRs); receive, from the network node, a request for an aperiodic (AP) CSI report; and transmit, to the network node, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report. Additionally, or alternatively, the communication manager 140 may perform one or more other operations described herein.

In some aspects, a network node (e.g., base station 110) may include a communication manager 150. As described in more detail elsewhere herein, the communication manager 150 may receive, from a UE, a P/SP CSI report that indicates an L1-RSRP/SINR measurement for each of a set of CMRs; transmit, to the UE, a request for an AP CSI report; and receive, from the UE, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report. Additionally, or alternatively, the communication manager 150 may perform one or more other operations described herein.

In some aspects, a UE (e.g., UE 120) may include a communication manager 140. As described in more detail elsewhere herein, the communication manager 140 may receive, from a network node, a CSI report configuration; and transmit, to the network node and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs, wherein a time domain beam prediction is based at least in part on the CSI report. Additionally, or alternatively, the communication manager 140 may perform one or more other operations described herein.

In some aspects, a network node (e.g., base station 110) may include a communication manager 150. As described in more detail elsewhere herein, the communication manager 150 may transmit, to a UE, a CSI report configuration; receive, from the UE and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs; and perform a time domain beam prediction based at least in part the CSI report. Additionally, or alternatively, the communication manager 150 may perform one or more other operations described herein.

As indicated above, FIG. 1 is provided as an example. Other examples may differ from what is described with regard to FIG. 1.

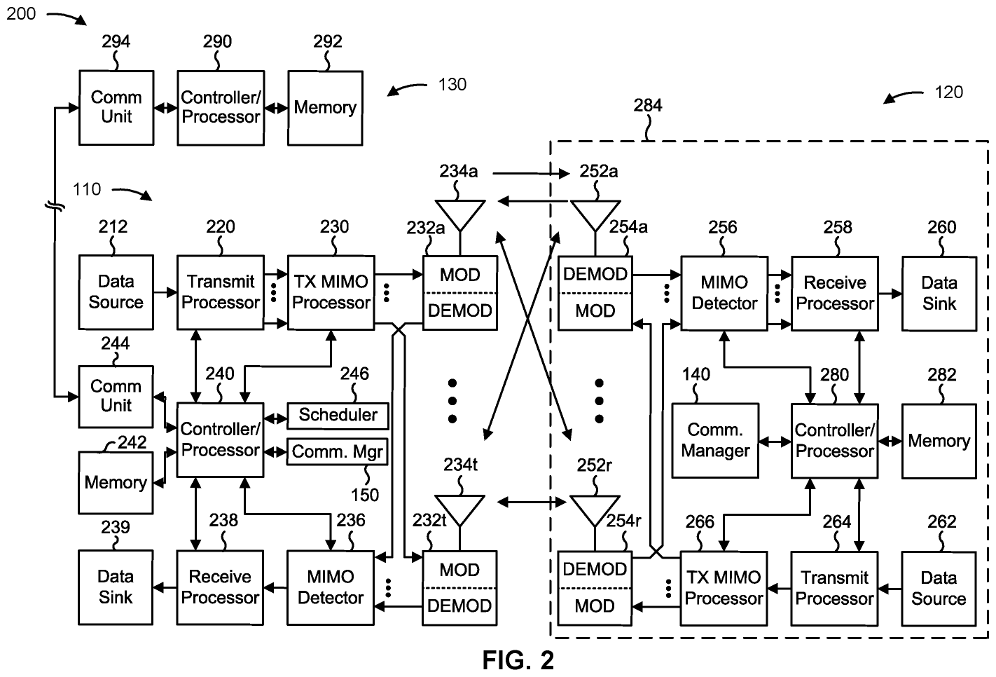

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

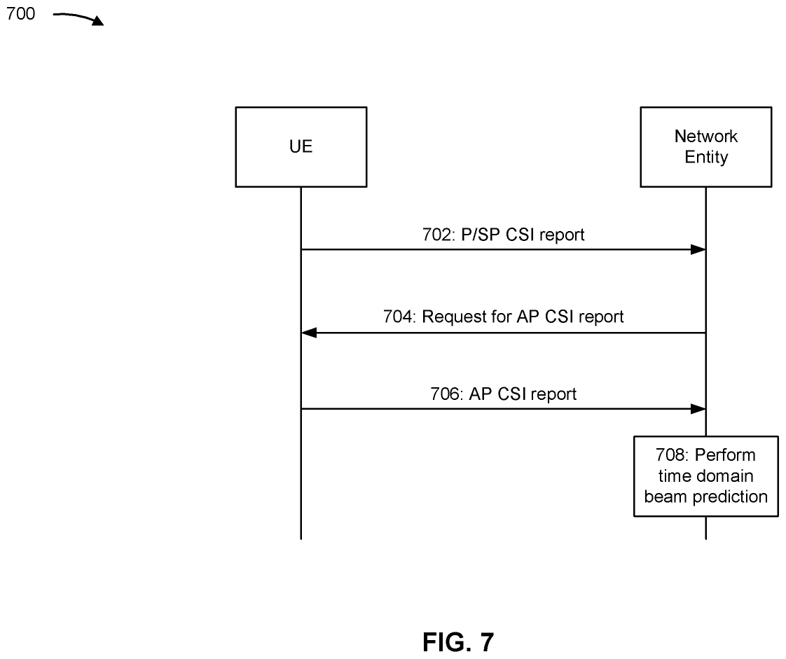

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-18).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-18).

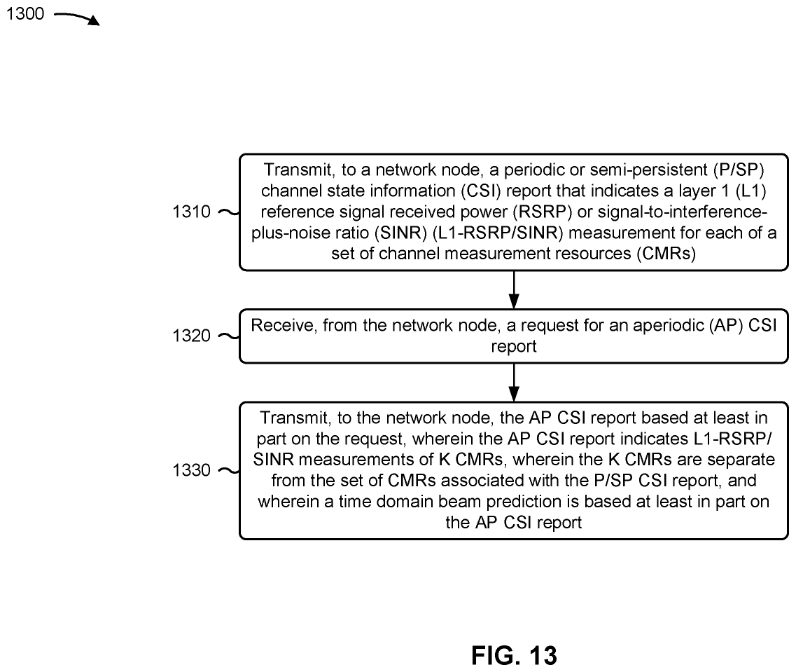

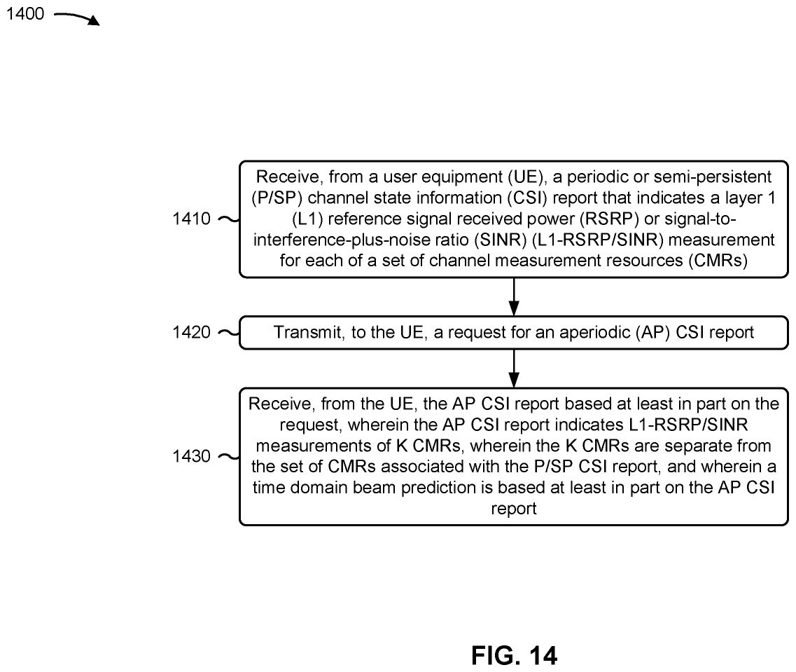

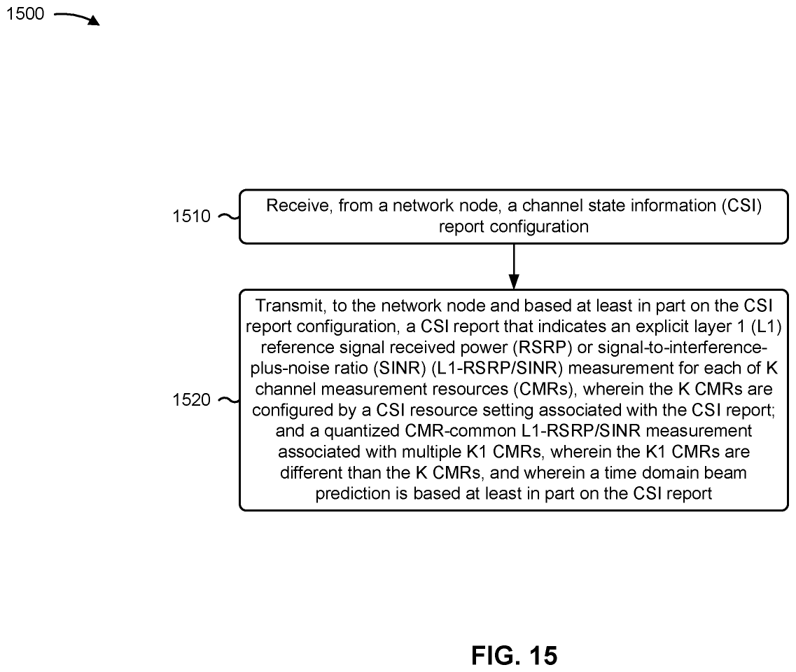

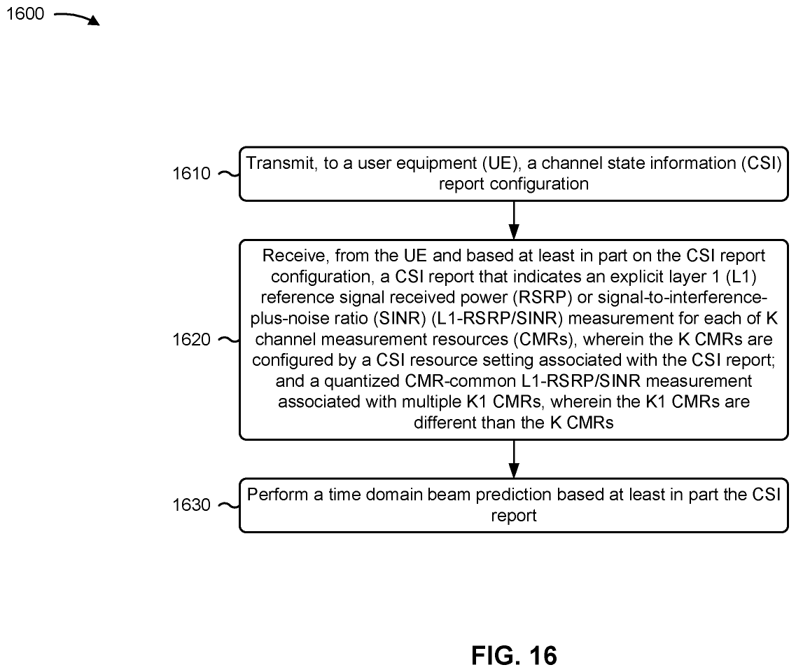

The controller/processor 240 of the base station 110, the controller/processor 280 of the UE 120, and/or any other component(s) of FIG. 2 may perform one or more techniques associated with time domain beam prediction using CSI reporting, as described in more detail elsewhere herein. For example, the controller/processor 240 of the base station 110, the controller/processor 280 of the UE 120, and/or any other component(s) of FIG. 2 may perform or direct operations of, for example, process 1300 of FIG. 13, process 1400 of FIG. 14, process 1500 of FIG. 15, process 1600 of FIG. 16, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1300 of FIG. 13, process 1400 of FIG. 14, process 1500 of FIG. 15, process 1600 of FIG. 16, and/or other processes as described herein. In some examples, executing instructions may include running the instructions, converting the instructions, compiling the instructions, and/or interpreting the instructions, among other examples.

In some aspects, a UE (e.g., UE 120) includes means for transmitting, to a network node, a P/SP CSI report that indicates a L1-RSRP/SINR measurement for each of a set of CMRs; means for receiving, from the network node, a request for an AP CSI report; and/or means for transmitting, to the network node, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., base station 110) includes means for receiving, from a UE, a P/SP CSI report that indicates an L1-RSRP/SINR measurement for each of a set of CMRs; means for transmitting, to the UE, a request for an AP CSI report; and/or means for receiving, from the UE, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a UE (e.g., UE 120) includes means for receiving, from a network node, a CSI report configuration; and/or means for transmitting, to the network node and based at least in part on the CSI report configuration, a CSI report that indicates: an explicit L1-RSRP/SINR measurement for each of K CMRs, wherein the K CMRs are configured by a CSI resource setting associated with the CSI report; and/or a quantized CMR-common L1-RSRP/SINR measurement associated with multiple K1 CMRs, wherein the K1 CMRs are different than the K CMRs, wherein a time domain beam prediction is based at least in part on the CSI report. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., base station 110) includes means for transmitting, to a UE, a CSI report configuration; means for receiving, from the UE and based at least in part on the CSI report configuration, a CSI report that indicates: an explicit L1-RSRP/SINR measurement for each of K CMRs, wherein the K CMRs are configured by a CSI resource setting associated with the CSI report; and/or a quantized CMR-common L1-RSRP/SINR measurement associated with multiple K1 CMRs, wherein the K1 CMRs are different than the K CMRs; and/or means for performing a time domain beam prediction based at least in part the CSI report. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

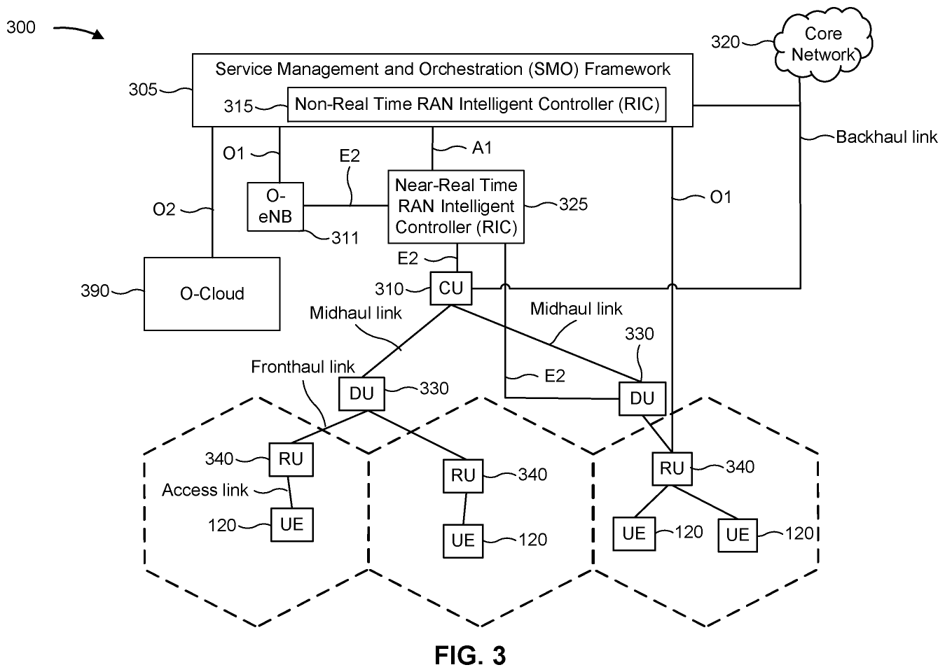

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, AP, a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as Al policies).

As indicated above, FIG. 3 is provided as an example. Other examples may differ from what is described with regard to FIG. 3.

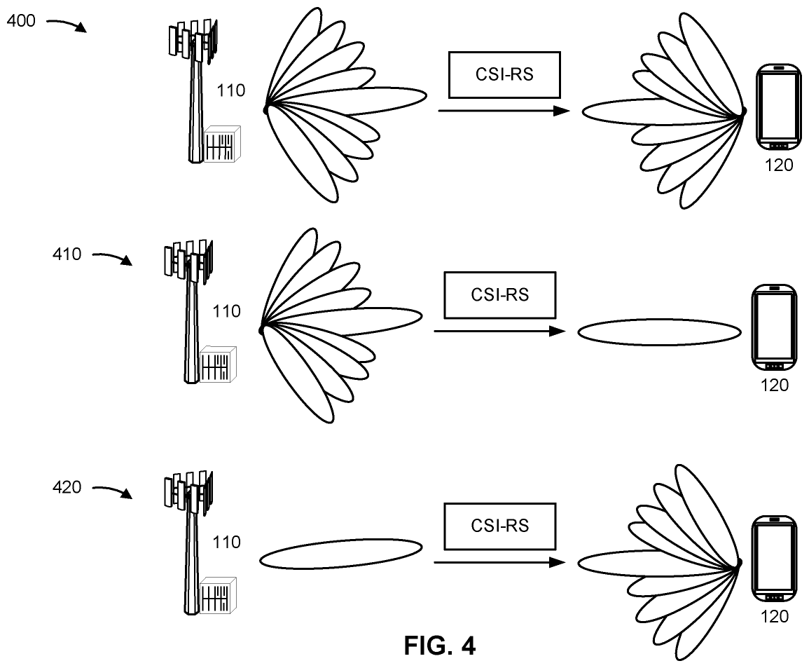

FIG. 4 is a diagram illustrating examples 400, 410, and 420 of beam management procedures, in accordance with the present disclosure. As shown in FIG. 4, examples 400, 410, and 420 include a UE 120 in communication with a base station 110 in a wireless network (e.g., wireless network 100). However, the devices shown in FIG. 4 are provided as examples, and the wireless network may support communication and beam management between other devices (e.g., between a UE 120 and a base station 110 or TRP, between a mobile termination node and a control node, between an IAB child node and an IAB parent node, and/or between a scheduled node and a scheduling node). In some aspects, the UE 120 and the base station 110 may be in a connected state (e.g., an RRC connected state).

As shown in FIG. 4, example 400 may include a base station 110 and a UE 120 communicating to perform beam management using channel state information reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the base station 110 to the UE 120. The CSI-RSs may be configured to be periodic (e.g., using RRC signaling), semi-persistent (e.g., using MAC control element (MAC-CE) signaling), and/or aperiodic (e.g., using downlink control information (DCI)).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 may sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 400 has been described in connection with CSI-RSs, the first beam management process may also use synchronization signal blocks (SSBs) for beam management in a similar manner as described above.

As shown in FIG. 4, example 410 may include a base station 110 and a UE 120 communicating to perform beam management using CSI-RSs. Example 410 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 4 and example 410, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 may sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the base station 110 may perform the third beam management procedure before performing the second beam management procedure, and/or the UE 120 and the base station 110 may perform a similar beam management procedure to select a UE transmit beam.

A UE may initially be in an RRC idle state or an RRC inactivate state. The UE may perform an initial access and beam management after entering an RRC connected state. The beam management may include P1, P2, and P3 beam management procedures, as described herein. The UE may also perform beam management using an artificial intelligence (AI) or machine learning (ML) based approach. The UE may perform a beam failure detection (BFD), and the UE may perform a beam failure recovery (BFR) based at least in part on the BFD. When the BFR is not successful, the UE may declare a radio link failure (RLF).

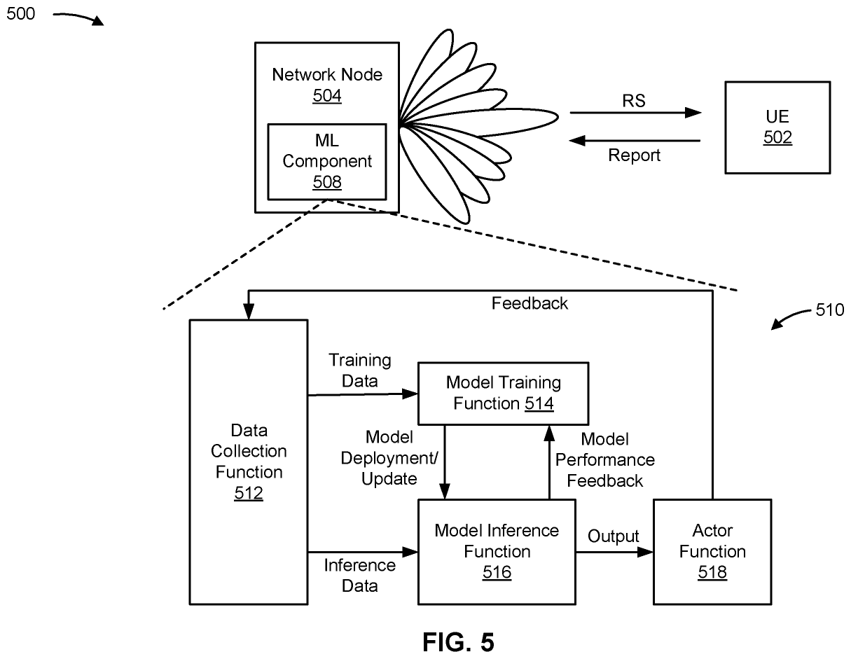

FIG. 5 is a diagram illustrating an example 500 of wireless communications, in accordance with the present disclosure.

As shown in FIG. 5, a network node 504 (e.g., base station 110) may communicate with a UE 502 (e.g., UE 120) to perform beam management using reference signals. The reference signals may include any number of different types of reference signals such as, for example, SSBs, CSI-RSs, sounding reference signals (SRSs), DMRSs, and/or beam failure detection reference signals (BFD-RSs), among other examples. Beam management may include any number of different procedures related to beams. For example, beam management may include beam sweeping procedures, SSB and random access channel (RACH) association, beam selection procedures, and/or beam refinement procedures, among other examples.

The network node 504 may transmit a reference signal (RS) and the UE 502 may receive the reference signal. The UE 502 may obtain one or more measurements associated with the reference signal and, based on the one or more measurements, may perform a wireless communication task. For example, the UE 502 may transmit a report to the network node 504 that reports the one or more measurements and/or information determined based on the one or more measurements. The UE 502 may adjust a wireless communication parameter based on the one or more measurements. In some cases, the network node 504 may perform one or more wireless communication tasks based on receiving the report from the UE 502.

The network node 504 may include an ML component 508. The ML component may include one or more ML models for facilitating wireless communication tasks. For example, ML models may be used to facilitate determining parameter values associated with measurements. An ML model may be used to estimate a group of parameters (e.g., interference and/or CSI, among other examples) from a common set of inputs (e.g., signal measurements) on current and/or future resources. For example, an ML model may jointly estimate the interference and the CSI on future resources using the same input CSI-RS. In another example, an ML model may estimate the interference on multiple future slots and/or symbols using the same input measurements.

In some cases, to develop a machine learning model of the ML component 508, the UE 502 may be configured to collect data and provide the collected data to the ML component 508. The ML component 508 may be configured to implement a functional framework 510 for developing the ML model. The functional framework 510 may include a data collection function 512, a model training function 514, a model inference function 516, and an actor function 518. The data collection function 512 may provide training data as input data to the model training function 514 and inference data as input to the model inference function 516. Examples of input data may include measurements from network nodes, feedback from the actor function 518, and/or output from an ML model. In some cases, the data collection function 512 may be configured to simply collect and provide data. For example, in some cases, the data collection function 512 may be configured so that ML algorithm specific data preparation (e.g., data pre-processing, data cleaning, data formatting, and/or transformation, among other examples) is not performed by the data collection function 512.

The model training function 514 may perform ML model training, validation, and/or testing, among other examples. The model training function 514 may also perform data preparation (e.g., data pre-processing, data cleaning, data formatting, and/or transformation, among other examples) based on training data delivered by the data collection function 512. The model training function 514 may deploy an ML model and/or update of the ML model to the model inference function 516. The model inference function 516 may provide ML model inference output (e.g., predictions, classifications, estimations, and/or decisions, among other examples). In some cases, the model inference function 516 may provide model performance feedback to the model training function 514. The model inference function 516 may also perform data preparation (e.g., data pre-processing, data cleaning, data formatting, and/or transformation, among other examples) based on inference data delivered by the data collection function 512. The actor function 518 may receive the output from the model inference function 516 and perform one or more wireless communication tasks based on the output. The actor function 518 may provide feedback, which may be stored by the data collection function 512 for use as training data and/or inference data.

As indicated above, FIG. 5 is provided as an example. Other examples may differ from what is described with respect to FIG. 5.

AI/ML-based predictive beam management may involve beam management using AI/ML. One problem with traditional beam management procedures is that beam qualities/failures are always identified via measurements, which may involve more power/overhead needed to achieve good performance. Further, beam accuracy may be limited due to restrictions on power/overhead, and latency/throughput may be impacted by beam resuming efforts. AI/ML-based predictive beam management may provide predictive beam management in a spatial domain, time domain, and/or frequency domain, which may result in power/overhead reduction and/or accuracy/latency/throughput improvement. AI/ML-based predictive beam management may predict non-measured beam qualities, which may result in lower power/overhead or better accuracy. AI/ML-based predictive beam management may predict future beam blockage/failure, which may result in better latency/throughput. AI/ML-based predictive beam management may be useful because beam prediction is a highly non-linear problem. Predicting future Tx beam qualities may depend on a UE's moving speed/trajectory, Rx beams used or to be used, and/or interference, which may be difficult to model via conventional statistical signaling processing techniques.

AI/ML-based predictive beam management may involve the prediction of beams via AI/ML at the UE or at a network node, which may involve a tradeoff between performance and UE power. In order to predict future DL-Tx beam qualities, the UE may have more observations (via measurements) than the network node (via UE feedbacks). Thus, beam prediction at the UE may outperform beam prediction at the network node, but may involve more UE power consumption. Model training may occur at the network node or at the UE. For model training at the network node, data may be collected via an enhanced air interface or via application-layer approaches. For model training at the UE, additional UE computation/buffering efforts may be needed by model training and data storage.

In an AI/ML-based time domain beam prediction, the network node may, at a first time point, transmit a plurality of first CSI-RSs/SSBs. The UE may perform L1-RSRP measurements based at least in part on the plurality of first CSI-RSs/SSBs. The UE may report the first L1-RSRP measurements to the network node. The network node may, at a second time point, transmit a plurality of second CSI-RSs/SSBs. The UE may perform second L1-RSRP measurements based at least in part on the plurality of second CSI-RSs/SSBs. The UE may report the second L1-RSRP measurements to the network node. The network node may, at a third time point, transmit a plurality of third CSI-RSs/SSBs. The UE may perform third L1-RSRP measurements based at least in part on the plurality of third CSI-RSs/SSBs. The UE may report the third L1-RSRP measurements to the network node. A time series of L1-RSRP measurements (e.g., the first, second, and third L1-RSRP measurements) may be provided as an input to an ML model. When beam prediction is performed at the network node, the input may be L1-RSRP measurements reported by the UE. When the beam prediction is performed at the UE, the input may be L1-RSRP measurements measured by the UE. The ML model may produce an output based at least in part on the input, where the output may indicate a prediction of L1-RSRP measurements, a prediction of candidate beam(s), and/or a prediction of beam failure/blockage. The AI/ML-based time domain beam prediction may provide reduced UE power or UE-specific reference signal overhead, as well as better latency and throughput.

A UE may be configured with one or more parameters for joint SSB resource indicator (SSBRI) and/or CSI-RS resource indicator (CRI) and L1-RSRP and/or L1-SINR beam reporting. The UE may report a set of CSI measurements associated with one or more beams. For example, the UE may be configured with parameters ReportQuantity ssb-Index-RSRP, ssb-Index-SINR, cri-RSRP, and/or cri-SINR. In some cases, the UE may report CSI measurements (e.g., using a parameter nrofReportedRS). The reporting of CSI measurements may be configured (e.g., using RRC) depending on the capability of the UE.

In some cases, for example, the reporting may include physical layer (L1)-RSRP reporting. In some cases, for a strongest SSBRI (e.g., an SSBRI corresponding to a signal strength and/or quality that is greater than the signal strength and/or quality of any other SSBRI that is measured by the UE during a specified time period), seven bits may be used to report a corresponding RSRP (in the range of [−140, −44] dBm with a 1 dBm step size). For remaining SSBRI(s) and/or CRI(s), four bits may be used to report a differential RSRP in the range of [0, −30] dB with a 2 dB step size and a reference to the L1-RSRP of the strongest SSBRI and/or CRI. In some cases, the reporting may include L1-SINR reporting. In some cases, for the strongest SSBRI and/or CRI, seven bits may be used to report SINR in the range of [−23, 40] dB with a 0.5 dB step size. For remaining SSBRI(s)/CRI(s), four bits may be used to report a differential SINR in the range of [0, −15] dB with a 1 dB step size and a reference to L1-SINR of the strongest SSBRI/CRI.

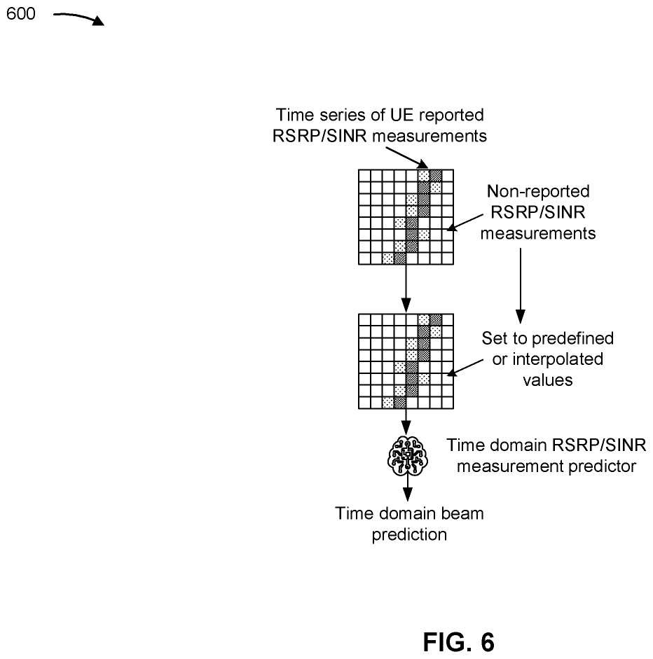

FIG. 6 is a diagram illustrating an example 600 of time domain beam prediction, in accordance with the present disclosure.

As shown by FIG. 6, a network node based time domain change/quality beam prediction may offload a UE AI/ML inference complexity and power consumption. An input to a time domain L1-RSRP/SINR measurement predictor, which may operate at the network node, may be UE reported L1-RSRP/SINR measurements via a background periodic channel state information (P-CSI) report with an extended periodicity (e.g., 80 ms). The network node may receive a time series of UE reported L1-RSRP/SINR measurements. Some L1-RSRP/SINR measurements may not be reported by the UE. The L1-RSRP/SINR measurements with respect to non-reported reference signals may be set to predefined values, or the L1-RSRP/SINR measurements may be determined based at least in part on interpolated/predicted values.

A first problem is that the L1-RSRP/SINR measurements with respect to non-reported reference signals may need to be set to predefined values or interpolated/predicted values, which may degrade a confidential level of predicted L1-RSRP/SINR measurements. The confidential level may be captured via an L1-RSRP/SINR measurement variance prediction. On the other hand, constantly reporting L1-RSRP/SINR measurements with respect to a plurality of beams (e.g., all beams) may increase an overhead and/or degrade a delivery reliability of the reports.

A low confidence level of predicted L1-RSRP/SINR measurements may be due to several reasons. First, the low confidence level may be due to a beam change that will happen. Second, the low confidence level may be due to a lack of L1-RSRP/SINR measurements regarding those non-reported reference signals. In other words, the low confidence level may be due to an insufficient input of L1-RSRP/SINR measurements due to the non-reported L1-RSRP/SINR measurements. When the low confidence level is predicted at the network node, the network node may trigger SP or AP L1-RSRP/SINR measurement reports more frequently as compared to background P-CSI-reports. This approach may lead to unnecessarily additional UE power consumption when the actual reason is due to the lack of L1-RSRP/SINR measurements regarding those non-reported reference signals.

A second problem is that the L1-RSRP/SINR measurements with respect to non-reported reference signals may need to be set to predefined values or interpolated/predicted values by the network node, which may degrade an accuracy of predicted L1-RSRP/SINR measurements. The predefined values may be CMR common L1-RSRP/SINR measurement values. In some cases, the UE may be better suited to determine what values to be set for remaining weaker L1-RSRP/SINR measurements, as opposed to the network node.

As indicated above, FIG. 6 is provided as an example. Other examples may differ from what is described with respect to FIG. 6.

In various aspects of techniques and apparatuses described herein, to address the first problem, a UE may transmit, to a network node, a P/SP CSI report that indicates an L1-RSRP/SINR measurement for each of a set of CMRs. The UE may receive, from the network node, a request for an AP CSI report. The request may be based at least in part on a low confidence level associated with the P/SP CSI report. The UE may transmit, to the network node, the AP CSI report based at least in part on the request. The AP CSI report may indicate L1-RSRP/SINR measurements of K CMRs. The K CMRs may be separate from the set of CMRs associated with the P/SP CSI report. A time domain beam prediction may be based at least in part on the AP CSI report. In some aspects, when the low confidence level is predicted at the network node, the network node may dynamically trigger AP L1-RSRP/SINR measurement reports to request the UE to report all/some of the missing L1-RSRP/SINR measurements. In other words, the network node may dynamically trigger redundant L1-RSRP/SINR measurement reports.

In various aspects of techniques and apparatuses described herein, to address the second problem, the UE may receive, from the network node, a CSI report configuration. The UE may transmit, to the network node and based at least in part on the CSI report configuration, a CSI report. The CSI report may indicate an explicit L1-RSRP/SINR measurement for each of K CMRs. The K CMRs may be configured by a CSI resource setting associated with the CSI report. The CSI report may indicate a quantized CMR-common L1-RSRP/SINR measurement associated with multiple K1 CMRs. The K1 CMRs may be different than the K CMRs. A time domain beam prediction may be based at least in part on the CSI report.

In some aspects, the UE may quantize L1-RSRP/SINR measurements associated with a plurality of remaining weaker CMRs (e.g., all remaining weaker CMRs), to a common L1-RSRP measurement value, based at least in part on criterion such as minimum mean square error (MMSE), which may provide a better accuracy than a value predicted by the network node. In other words, the UE may determine and report which value the remaining weaker L1-RSRP/SINR measurements should be used for setting to the CMR common L1-RSRP/SINR measurement value. Such reporting of an additional L1-RSRP measurement may introduce only limited additional overhead. Thus, the UE may be configured with signaling to support such CMR-common L1-RSRP/SINR measurement quantization and reporting schemes, which may result in better network node based time domain beam prediction with marginal uplink overhead.

FIG. 7 is a diagram illustrating an example 700 associated with time domain beam prediction using CSI reporting, in accordance with the present disclosure. As shown in FIG. 7, example 700 includes communication between a UE (e.g., UE 120) and a network node (e.g., base station 110). In some aspects, the UE and the network node may be included in a wireless network, such as wireless network 100.

As shown by reference number 702, the UE may transmit, to the network node, a P/SP CSI report that indicates an L1-RSRP/SINR measurement for each of a set of CMRs. For example, the P/SP CSI report may indicate a first L1-RSRP/SINR measurement for a first CMR, a second L1-RSRP/SINR measurement for a second CMR, and so on. The P/SP report may be associated with a high confidence level or a low confidence level.

As shown by reference number 704, the UE may receive, from the network node, a request for an AP CSI report. The request may be based at least in part on the low confidence level associated with the P/SP CSI report. In other words, the network node may receive the P/SP report, determine that the P/SP report is associated with the low confidence level, and then transmit the request for the AP CSI report.

As shown by reference number 706, the UE may transmit, to the network node, the AP CSI report based at least in part on the request. The AP CSI report may indicate L1-RSRP/SINR measurements of K CMRs. The K CMRs may be separate from the set of CMRs associated with the P/SP CSI report. In other words, the AP CSI report may indicate the L1-RSRP/SINR measurements of the K CMRs, which may be different than L1-RSRP/SINR measurements for the set of CMRs indicated by the P/SP report.

In some aspects, with dynamically triggered additional L1 reports, the UE may be configured or activated with the P/SP CSI report, whose report quantity may include at least L1-RSRP/SINR measurements of a number of reported reference signal (RS) (NrofReportedRS) CMRs (along with corresponding CMR-IDs) associated with the P/SP CSI report. The UE may be further configured with the AP CSI report associated with the P/SP CSI report, whose report quantity includes at least L1-RSRP/SINR measurements of K CMRs, which may be different from the CMR IDs in a most recently reported P/SP CSI report. The UE may be dynamically triggered by the network node to report the AP CSI report.

As an example, the UE may transmit, to the network node, three P/SP CSI reports carrying two (e.g., NrofReportedRS=2) strongest L1-RSRP/SINR measurements and corresponding CMR-IDs. The first and second P/SP CSI reports may be associated with high confidence levels. A third P/SP CSI report may be associated with a low confidence level, in which case the network node may transmit an AP CSI request to the UE. Based at least in part on the AP CSI request, the UE may transmit a dynamically triggered AP CSI report carrying K L1-RSRP/SINR measurements regarding CMRs different from the third P/SP CSI report. Additional high confidence levels may result in P/SP CSI reports. Additional low confidence levels may trigger more dynamically triggered AP CSI reports.

In some aspects, the UE may determine the K CMRs based at least in part on one or more of: a standard predefinition, a network node pre-configuration, or a dynamic indication from the network node. In some aspects, the UE may determine the K CMRs based at least in part on remaining strongest CMRs that are not included in the set of CMRs associated with the P/SP CSI report. In some aspects, the UE may determine the K CMRs based at least in part on remaining weakest CMRs that are not included in the set of CMRs associated with the P/SP CSI report. In some aspects, the UE may determine the K CMRs based at least in part on remaining CMRs, within a certain RSRP/SINR range, that are not included in the set of CMRs associated with the P/SP CSI report. In some aspects, the UE may determine the K CMRs based at least in part on a plurality of remaining CMRs that are not included in the set of CMRs associated with the P/SP CSI report. In some aspects, the UE may determine the K CMRs based at least in part on an indication in the request for the AP CSI report that indicates CMR identifiers (IDs) associated with the K CMRs.

In some aspects, the value of K CMRs may be determined using numerous mechanisms. The value of K CMRs may be predefined. The UE may report a maximum supported value of K via a capability signaling, and the value of K may be based at least in part on the capability signaling. The value of K may be preconfigured by the network node or dynamically indicated by the network node.

In some aspects, the UE may determine which K CMRs should be considered when reporting the L1-RSRP/SINR measurements based at least in part on a standard pre-definition or a network node pre-configuration or indication. For example, the network node may preconfigure which K CMRs should be indicated for an associated AP CSI report, or the network node may indicate which K CMRs should be indicated when triggering the associated AP CSI report. In some aspects, the K CMRs indicated in the AP CSI report may include remaining strongest CMRs. The UE may first identify CMRs reported in the most recent P/SP CSI report, and then the UE may identify K remaining strongest CMRs associated with the same measurement occasion. In some aspects, the K CMRs indicated in the AP CSI report may include remaining weakest CMRs. The UE may identify the remaining weakest CMRs associated with the same measurement occasion as the most recent P/SP CSI report. In some aspects, the K CMRs indicated in the AP CSI report may include remaining CMRs within a certain RSRP/SINR measurement range. The UE may identify a differential RSRP/SINR measurement range referring to the weakest RSRP/SINR measurement reported in the most recent P/SP CSI report, where the differential RSRP/SINR measurement range may be based at least in part on a standard pre-definition or a network node pre-configuration. The UE may further report at most K CMRs and corresponding RSRP/SINR measurement values, where the RSRP/SINR measurement values may be within the differential RSRP/SINR measurement range. In some aspects, the K CMRs indicated in the AP CSI report may include a plurality of remaining CMRs (e.g., all CMRs). In some aspects, the K CMRs indicated in the AP CSI report may be based at least in part on CMR-IDs that are explicitly and dynamically indicated by the network node when triggering the AP CSI report.

In some aspects, the L1-RSRP/SINR measurements of the K CMRs may be quantized L1-RSRP/SINR measurements. The quantized L1-RSRP/SINR measurements may be based at least in part on a differential quantization or an absolute quantization with respect to a strongest or weakest L1-RSRP/SINR measurement of a set of L1-RSRP/SINR measurements associated with the set of CMRs. A quantization may be based at least in part on a standard predefinition, a network node pre-configuration, and/or a dynamic indication from the network node via the request for the AP CSI report

In some aspects, the quantization of RSRP/SINR measurements regarding the K CMRs may be based on one of several options. In a first option, which may provide lower overhead, a plurality of RSRP/SINR measurements (e.g., all RSRP/SINR measurements) regarding the K CMRs carried in the AP CSI report may be quantized differentially referring to the strongest/weakest RSRP/SINR measurement within the P/SP CSI report. In a second option, which may provide better granularity: the strongest RSRP/SINR measurement within the AP CSI report may be quantized absolutely, while remaining RSRP/SINR measurements may be quantized differentially referring to the strongest/weakest RSRP/SINR measurement carried in the AP CSI report. In a third option, which may provide a compromise between overhead and granularity, some RSRP/SINR measurements may be quantized using the first option and other RSRP/SINR measurements may be quantized using the second option. As an example, the network node may request the UE to report both remaining strongest RSRP/SINR measurements and remaining weakest RSRP/SINR measurements. The UE may be standard predefined or configured by the network node to quantize the remaining strongest RSRP/SINR measurements via the first option and quantize the remaining weakest RSRP/SINR measurements via the second option.

In some aspects, the UE may use the first option, the second option, or the third option based at least in part on a standard pre-definition, which may be based at least in part on associations between different options. For example, when reporting the remaining strongest RSRP/SINR measurements, the first option may be used. As another example, when reporting the remaining weakest RSRP/SINR measurements, the second option may be used. In some aspects, the UE may use the first option, the second option, or the third option based at least in part on a network node pre-configuration. For example, the network node may configure the UE to use one of the options for an associated AP CSI report. In some aspects, the UE may use the first option, the second option, or the third option based at least in part on a dynamic indication received from the network entity. For example, the network may indicate one of the options when triggering the AP CSI report.

In some aspects, the UE may receive, from the network node, a CSI report configuration that indicates a CSI report setting ID associated with the P/SP CSI report, a determination scheme associated with the K CMRs, and/or a quantization scheme associated with the L1-RSRP/SINR measurements of K CMRs. In some aspects, the UE may receive, from the network node, a CSI report configuration that indicates a CSI report setting ID associated with the P/SP CSI report. The UE may receive an uplink grant DCI that indicates the request for the AP CSI report, where the uplink grant DCI may include one or more dedicated fields to indicate the determination scheme associated with the K CMRs and the quantization scheme associated with the L1-RSRP/SINR measurements of K CMRs.

In some aspects, a CSI associated report configuration information (AssociatedReportConfigInfo) information element (IE) associated with a preconfigured CSI triggering state may include a CSI report setting associated with the AP CSI report. The AssociatedReportConfigInfo IE may indicate a CSI report setting ID (CSI-ReportConfigId) associated with the P/SP CSI report. The CSI report setting ID may identify which P/SP CSI report is associated with the triggered AP CSI report. The AssociatedReportConfigInfo IE may indicate the determination scheme (RemainingCMRDetermination) of the K CMRs (e.g., remaining strongest CMRs, remaining weakest CMRs, remaining CMRs within a certain RSRP/SINR measurement range, all remaining CMRs, and/or CMRs associated with CMR-IDs that are explicitly or dynamically indicated by the network node when triggering the AP CSI report). The AssociatedReportConfigInfo IE may indicate the quantization scheme (quantizationSchemeFor Remaining (MRs) of the K L1-RSRP/SINR measurements (e.g., all L1-RSRP/SINR measurements are quantized differentially, strongest L1-RSRP/SINR measurements are quantized absolutely while remaining L1-RSRP/SINR measurements are quantized differentially, or some L1-RSRP/SINR measurements are quantized absolutely while other L1-RSRP/SINR measurements are quantized differentially). In some aspects, the UE may identify which P/SP CSI report is associated with a corresponding AP CSI report, together with the determination scheme and the quantization scheme, based at least in part on the CSI-AssociatedReportConfigInfo IE associated with the triggered AP CSI report.

In some aspects, dedicated DCI fields may be used to indicate the determination scheme and the quantization scheme. The CSI report setting ID associated with the P/SP CSI report may be configured by the CSI-AssociatedReportConfigInfo IE, which may be associated with the preconfigured CSI triggering state including the CSI report setting associated with the AP CSI report. The CSI report setting ID may identify which P/SP CSI report is associated with the triggered AP CSI report. The determination scheme of the K CMRs and/or the quantization scheme of the K L1-RSRP/SINR measurements may be indicated by other dedicated fields within an uplink grant DCI requesting the AP CSI report. The uplink grant DCI may indicate the AP CSI request, which may trigger the AP CSI report, and the uplink grant DCI may include dedicated fields that indicate the determination scheme of the K CMRs and/or the quantization scheme of the K L1-RSRP/SINR measurements. In some aspects, the UE may identify which P/SP CSI report is associated with the corresponding AP CSI report, based at least in part on the CSI-AssociatedReportConfigInfo IE associated with the triggered AP CSI report. The UE may identify the determination scheme of the K CMRs and/or the quantization scheme of the K L1-RSRP/SINR measurements based at least in part on the dedicated fields indicated in the uplink grant DCI requesting the AP CSI report. When multiple AP CSI reports are triggered by a same uplink grant DCI, the UE may assume that the multiple AP CSI reports all follow the same determination scheme and quantization scheme indicated by the dedicated fields.

As shown by reference number 708, the network node may perform a time domain beam prediction based at least in part on the AP CSI report. For example, the network node may provide the AP CSI report, which may indicate the L1-RSRP/SINR measurements of K CMRs, as an input to a time domain L1-RSRP/SINR predictor. The time domain L1-RSRP/SINR predictor may provide, as an output, the time domain beam prediction.

As indicated above, FIG. 7 is provided as an example. Other examples may differ from what is described with regard to FIG. 7.

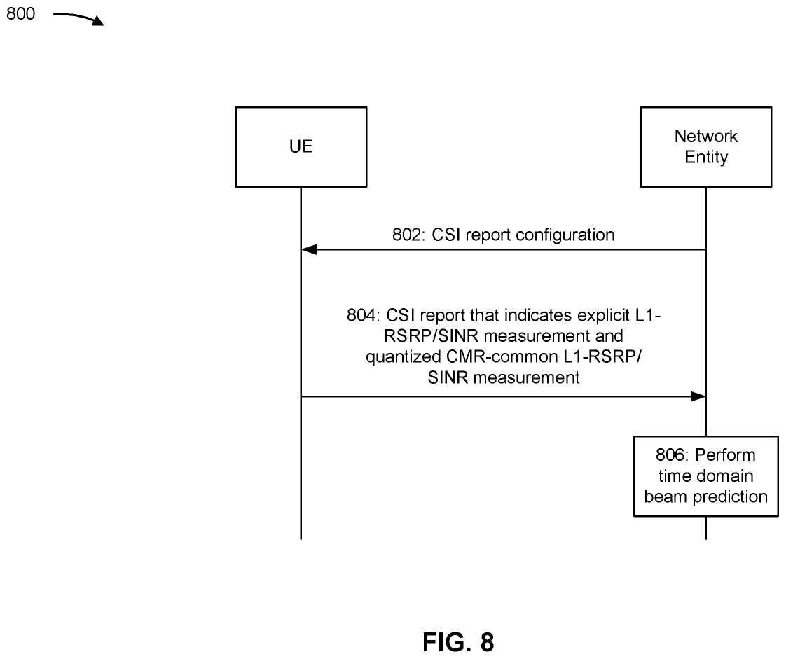

FIG. 8 is a diagram illustrating an example 800 associated with time domain beam prediction using CSI reporting, in accordance with the present disclosure. As shown in FIG. 8, example 800 includes communication between a UE (e.g., UE 120) and a network node (e.g., base station 110). In some aspects, the UE and the network node may be included in a wireless network, such as wireless network 100.

As shown by reference number 802, the UE may receive, from the network node, a CSI report configuration. The CSI report configuration may indicate one or more parameters that configure the UE to transmit a CSI report. The one or more parameters may be related to transmitting L1-RSRP/SINR measurements associated with CMRs, which may be indicated in the CSI report.

As shown by reference number 804, the UE may transmit, to the and based at least in part on the CSI report configuration, the CSI report. The CSI report may indicate an explicit L1-RSRP/SINR measurement for each of K CMRs. The K CMRs may be configured by a CSI resource setting associated with the CSI report. For example, the K CMRs may be configured based at least in part on the CSI report configuration. The CSI report may also indicate a quantized CMR-common L1-RSRP/SINR measurement associated with multiple K1 CMRs, where the K1 CMRs may be different than the K CMRs. The quantized CMR-common L1-RSRP/SINR measurement may be applicable to the multiple K1 CMRs and may approximate actual CMR-common L1-RSRP/SINR measurements of respective K1 CMRs

In some aspects, the UE may perform a CMR-common L1-RSRP/SINR quantization and reporting, to the network node, for multiple CMRs. The UE may be configured, by the network node, with the CSI report with a report quantity that includes explicit L1-RSRP/SINR measurements with respect to K CMRs out of N total CMRs that are configured by the CSI resource setting associated with the CSI report. The report quantity may include at least one CMR-common quantized L1-RSRP/SINR measurement associated with multiple K1 CMRs out of the N total CMRs, where the K1 CMRs may be different from the K CMRs. The UE may identify a certain quantization scheme with respect to the CMR-common quantized L1-RSRP/SINR measurement. The UE may report the CMR-common quantized L1-RSRP/SINR measurement along with other report quantities in the same CSI report. The UE may apply the CMR-common quantized L1-RSRP/SINR measurement to the K1 CMRs (e.g., all of the K1 CMRs), which may approximate respective actual L1-RSRP/SINR measurements of the K1 CMRs.

In some aspects, the UE may determine the K1 CMRs based at least in part on a difference between N total CMRs and the K CMRs. In some aspects, the UE may determine the K1 CMRs based at least in part on multiple preconfigured CMR subsets, where the quantized CMR-common L1-RSRP/SINR measurement may be for a CMR subset of the multiple preconfigured CMR subsets, and the quantized CMR-common L1-RSRP/SINR measurement may exclude the explicit L1-RSRP/SINR measurement for each of the K CMRs. In some aspects, the UE may determine the K1 CMRs based at least in part on multiple CMR subset pre-groupings, where each CMR subset pre-grouping of the multiple CMR subset pre-groupings may be associated with a quantity of subsets and a quantity of CMRs within each subset, and where the multiple CMR subset pre-groupings may be indicated in the CSI resource setting associated with the CSI report.

In some aspects, the UE may determine the K1 CMRs using a first option, a second option, or a third option. In the first option, the UE may determine that the K1 CMRs are all remaining N−K CMRs. The K1=N−K CMRs may be all of the remaining N−K CMRs except for the K CMRs associated with the K explicit L1-RSRP/SINR measurements. In the second option, the UE may determine the K1 CMRs based at least in part on preconfigured CMR subsets. The network node may further pre-separate the N total CMRs into multiple subsets in the CSI report/resource setting associated with the CSI report. The UE may report, for each subset, a CMR-common L1-RSRP/SINR measurement for CMRs within the subset. A calculation of the CMR-common L1-RSRP/SINR measurement may exclude the CMRs already included in the K CMRs with respect to the K explicit L1-RSRP/SINR measurements. In this option, the UE may determine the K1 CMRs based at least in part on configured multiple CMR sets in the CSI resource setting associated with the CSI report. The UE may report L1-RSRP/SINR measurements in ascending/descending order of subset IDs, without further reporting each subset ID. In the third option, the UE may determine the K1 CMRs based at least in part on multiple CMR subset pre-groupings. The network node may preconfigure multiple pre-separation options (in terms of quantity of subsets and quantity of CMRs within each subset) in the CSI report/resource setting associated with the CSI report, or the multiple pre-separation options may be predefined. As an example, the UE may select one of the options (e.g., a specific CMR subset pre-grouping) and indicate the selected option in the CSI report, and the UE may further report the CMR-common L1-RSRP/SINR measurements with respect to respective subsets. As another example, the UE may autonomously select one of the options based on the value of N and/or the value of K (e.g., a greater N may lead to a greater quantity of subsets), but in this case, the UE may not include a reporting of the selected option.

In some aspects, the UE may determine the CMR-common quantized L1-RSRP/SINR measurement based at least in part on a quantization metric. The quantization metric may be based at least in part on a standard predefinition, a network node pre-configuration or a network node dynamic indication, and/or a UE indication. For the standard predefinition, one or more quantization metrics may be predefined, such as MMSE applied for a past time domain window length, MMSE applied only for a current reporting instance, and/or one or more choices of quantity of bits, dynamic range, and step size to quantize the CMR-common L1-RSRP/SINR measurement. The past time domain window length may be based at least in part on a network node pre-configuration or a standard predefinition. For the network node pre-configuration, the network node may preconfigure one or more quantization metrics, which may be standard predefined. When multiple quantization metrics are preconfigured, one quantization metric may be identified as a default scheme. For the network node dynamic indication, for an AP CSI report, multiple AP CSI triggering configurations (e.g., an IE of a CSI-AssociatedReportConfigInfo associated with a preconfigured CSI triggering state) may be linked with a single AP CSI report setting. Each AP CSI triggering configuration may be configured with a different standard predefined quantization metric. The UE may identify the quantization metric based at least in part on a triggered AP CSI and the quantization scheme associated with the AP CSI triggering configuration. For the UE indication, the UE may select one of the standard predefined or network node preconfigured quantization metrics, and the CSI report may indicate an additional report quantity which allows the UE to report the quantization metric that is used for the CMR-common L1-RSRP/SINR measurement reported in the same CSI report.

In some aspects, the UE may perform a differential quantization for the CMR-common L1-RSRP/SINR measurement. The UE may differentially quantize the CMR-common L1-RSRP/SINR measurement based at least in part by referring to a strongest or a weakest L1-RSRP/SINR measurement of the K explicit L1-RSRP/SINR measurements. The quantized CMR-common L1-RSRP/SINR measurement may be differentially quantized with respect to the explicit L1-RSRP/SINR measurement, where the explicit L1-RSRP/SINR measurement may be a strongest explicit L1-RSRP/SINR measurement or a weakest explicit L1-RSRP/SINR measurement of the K explicit L1-RSRP/SINR measurements. A quantity of bits used for quantizing the CMR-common L1-RSRP/SINR measurement may be greater than a quantity of bits used for quantizing at least one of the K explicit L1-RSRP/SINR measurements, which may allow for better granularity without much additional overhead. The quantity of bits associated with the quantized CMR-common L1-RSRP/SINR measurement may be greater than the quantity of bits associated with the explicit L1-RSRP/SINR measurement.

In some aspects, the UE may transmit, to the network node, an indication of a subset ID associated with a strongest quantized CMR-common L1-RSRP/SINR measurement of multiple quantized CMR-common L1-RSRP/SINR measurements associated with respective CMR subsets. In some aspects, the UE may report the subset ID regarding a strongest CMR-common L1-RSRP/SINR measurement out of multiple CMR-common L1-RSRP/SINR measurements associated with a respective CMR subset. The UE may report the CMR-common L1-RSRP/SINR measurement with respect to the subset ID. Remaining CMR-common L1-RSRP/SINR measurements with respect to other CMR subsets may be differentially quantized (and reported) referring to a strongest CMR-common L1-RSRP/SINR measurement. A quantity of bits used for quantizing each of the remaining CMR subsets may be lower than a quantity of bits used for quantizing the strongest CMR-common L1-RSRP/SINR measurement. In some aspects, different quantization schemes may be CMR subset specifically, or pre-subset-separation-choice specifically, standard predefined, network node preconfigured or dynamically indicated, of UE reported.

As shown by reference number 806, the network node may perform a time domain beam prediction based at least in part on the CSI report. For example, the network node may provide the CSI report, which may indicate the explicit L1-RSRP/SINR measurements for the K CMRs and the quantized CMR-common L1-RSRP/SINR measurement associated with the multiple K1 CMRs, as an input to a time domain L1-RSRP/SINR predictor. The time domain L1-RSRP/SINR predictor may provide, as an output, the time domain beam prediction.

As indicated above, FIG. 8 is provided as an example. Other examples may differ from what is described with regard to FIG. 8.

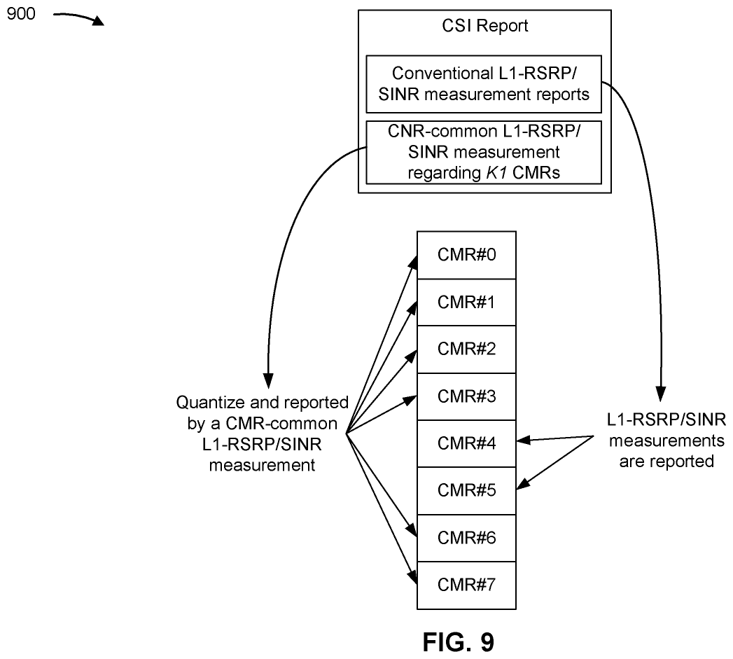

FIG. 9 is a diagram illustrating an example 900 associated with CSI reporting, in accordance with the present disclosure.

As shown by FIG. 9, a CSI report may include an L1-RSRP/SINR measurement report (e.g., a conventional L1-RSRP/SINR measurement report) and a CMR-common quantized L1-RSRP/SINR measurement regarding K1 CMRs. For example, the CSI report may indicate L1-RSRP/SINR measurements for each of CMR #4 and CMR #5. The CSI report may also indicate a CMR-common quantized L1-RSRP/SINR measurement for CMR #0, CMR #1, CMR #2, CMR #3, CMR #6, and CMR #7, where CMR #0, CMR #1, CMR #2, CMR #3, CMR #6, and CMR #7 may be the K1 CMRs. The CMR-common quantized L1-RSRP/SINR measurement may be applicable to or associated with all of the K1 CMRs, where the CMR-common quantized L1-RSRP/SINR measurement may approximate respective actual L1-RSRP/SINR measurements associated with the K1 CMRs.

As indicated above, FIG. 9 is provided as an example. Other examples may differ from what is described with regard to FIG. 9.

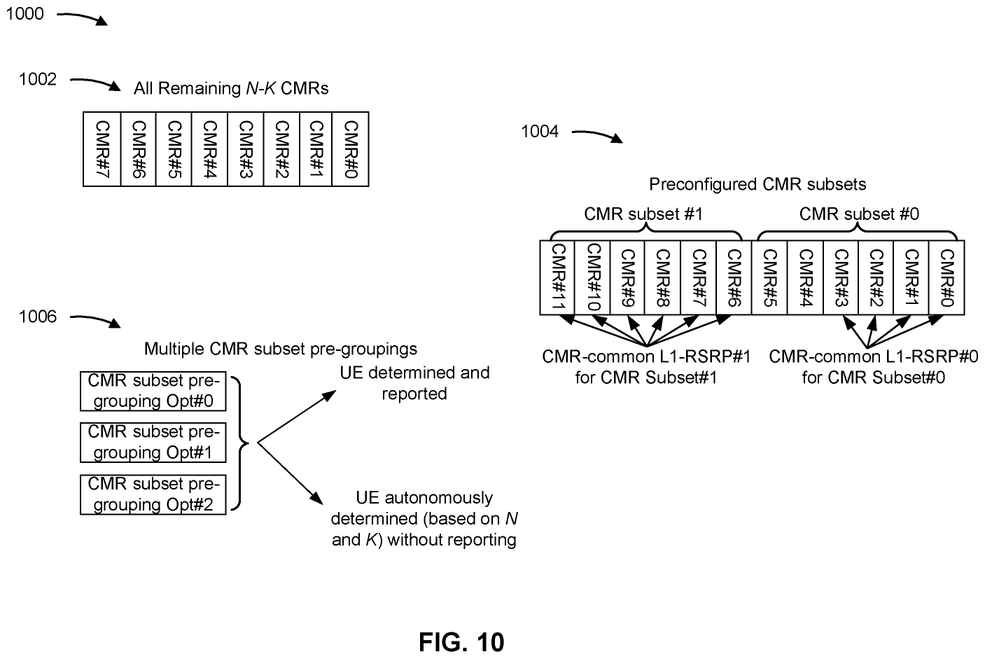

FIG. 10 is a diagram illustrating an example 1000 associated with CSI reporting, in accordance with the present disclosure.

As shown by reference number 1002, a UE may determine that K1 CMRs are all remaining N−K CMRs, such that K1=N−K. For example, N=8 CMRs may include CMR #0, CMR #1, CMR #2, CMR #3, CMR #4, CMR #5, CMR #6, and CMR #7, and N=2 CMRs may include CMR #4 and CMR #5. In this case, the UE may determine that K1=6 CMRs, which may include CMR #0, CMR #1, CMR #2, CMR #3, CMR #6, and CMR #7. As shown by reference number 1004, the UE may determine K1 CMRs based at least in part on preconfigured CMR subsets. A first CMR subset (CMR subset #0) may include CMR #0-5, and a second CMR subset (CMR subset #1) may include CMR #6-11. The UE may transmit, in a CSI report, a CMR-common L1-RSRP/SINR #0 measurement report for CMR subset #0, which may be associated with CMR #0-3 and exclude CMR #4 and CMR #5, which may be the K CMRs associated with the K explicit L1-RSRP/SINR measurements. The UE may transmit, in the CSI report, a CMR-common L1-RSRP/SINR #1 measurement report for CMR subset #1, which may be associated with CMR #6-11. As shown by reference number 1006, the UE may be configured with a first CMR subset pre-grouping option (CMR subset pre-grouping Opt #0), a second CMR subset pre-grouping option (CMR subset pre-grouping Opt #1), and a third CMR subset pre-grouping option (CMR subset pre-grouping Opt #2). The UE may select and report one of the CMR subset pre-grouping options in a CSI report, or alternatively, the UE may autonomously identify one of the options without reporting the selected option.

As indicated above, FIG. 10 is provided as an example. Other examples may differ from what is described with regard to FIG. 10.

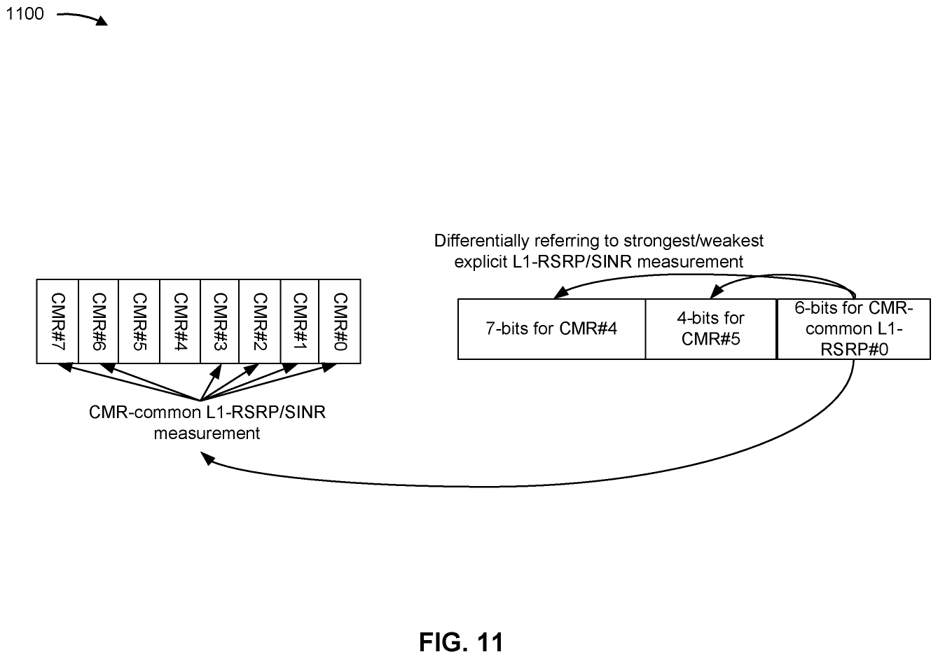

FIG. 11 is a diagram illustrating an example 1100 associated with CSI reporting, in accordance with the present disclosure.

As shown by FIG. 11, CMR #4 and CMR #5 may be associated with K explicit L1-RSRP/SINR measurements, and CMR #0, CMR #1, CMR #2, CMR #3, CMR #6, and CMR #7 may be associated with a CMR-common L1-RSRP/SINR measurement. A UE may use 7 bits to transmit, in a CSI report, an explicit L1-RSRP/SINR measurement for CMR #4. The UE may use 4 bits to transmit, in the CSI report, an explicit L1-RSRP/SINR measurement for CMR #5. The UE may use 6 bits to transmit, in the CSI report, a CMR-common L1-RSRP/SINR measurement for CMR #0, CMR #1, CMR #2, CMR #3, CMR #6, and CMR #7. The CMR-common L1-RSRP/SINR measurement may be differentially quantized referring to a strongest/weakest explicit L1-RSRP/SINR measurement for CMR #4 (7 bits) and CMR #5 (5 bits).

As indicated above, FIG. 11 is provided as an example. Other examples may differ from what is described with regard to FIG. 11.

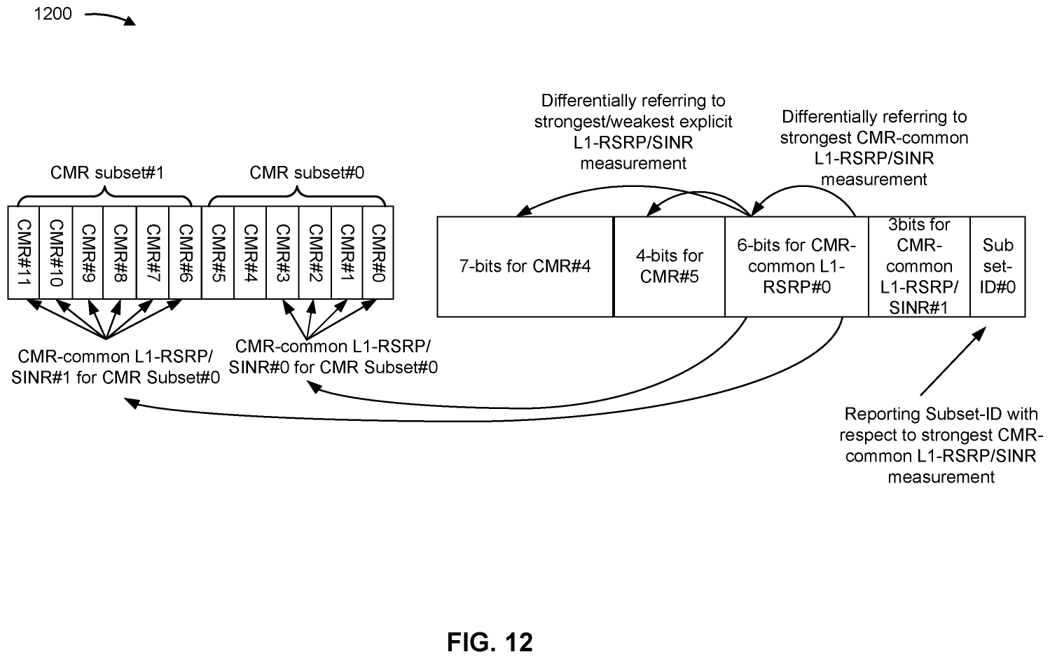

FIG. 12 is a diagram illustrating an example 1200 associated with CSI reporting, in accordance with the present disclosure.

As shown by FIG. 12, a first CMR subset (CMR subset #0) may include CMR #0-5, and a second CMR subset (CMR subset #1) may include CMR #6-11. A UE may use 7 bits to transmit, in a CSI report, an explicit L1-RSRP/SINR measurement for CMR #4. The UE may use 4 bits to transmit, in the CSI report, an explicit L1-RSRP/SINR measurement for CMR #5. The UE may use 6 bits to transmit, in the CSI report, a CMR-common L1-RSRP/SINR measurement for CMR #0-3 of CMR subset #0. The CMR-common L1-RSRP/SINR measurement for CMR #0-3 of CMR subset #0 may be differentially quantized referring to a strongest/weakest explicit L1-RSRP/SINR measurement for CMR #4 (7 bits) and CMR #5 (5 bits). The UE may use 3 bits to transmit, in the CSI report, a CMR-common L1-RSRP/SINR measurement for CMR #6-11 of CMR subset #1. The CMR-common L1-RSRP/SINR measurement for CMR #6-11 of CMR subset #1 may be differentially quantized referring to a strongest CMR-common L1-RSRP/SINR measurement for CMR subset #0 (6 bits). Further, the UE may transmit an indication of a subset ID (e.g., SIB ID #0), where the subset ID may be with respect to the strongest CMR-common L1-RSRP/SINR measurement.

As indicated above, FIG. 12 is provided as an example. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120) performs operations associated with time domain beam prediction using CSI reporting.

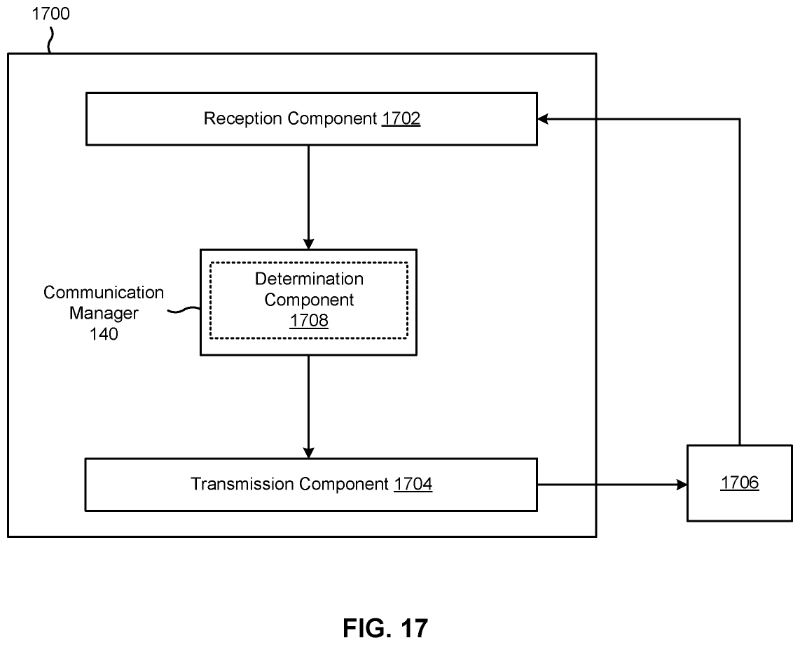

As shown in FIG. 13, in some aspects, process 1300 may include transmitting, to a network node, a P/SP CSI report that indicates an L1-RSRP/SINR measurement for each of a set of CMRs (block 1310). For example, the UE (e.g., using communication manager 140 and/or transmission component 1704, depicted in FIG. 17) may transmit, to a network node, a P/SP CSI report that indicates an L1-RSRP/SINR measurement for each of a set of CMRs, as described above.

As further shown in FIG. 13, in some aspects, process 1300 may include receiving, from the network node, a request for an AP CSI report (block 1320). For example, the UE (e.g., using communication manager 140 and/or reception component 1702, depicted in FIG. 17) may receive, from the network node, a request for an AP CSI report, as described above.

As further shown in FIG. 13, in some aspects, process 1300 may include transmitting, to the network node, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report (block 1330). For example, the UE (e.g., using communication manager 140 and/or transmission component 1704, depicted in FIG. 17) may transmit, to the network node, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report, as described above.

Process 1300 may include additional aspects, such as any single aspect or any combination of aspects described below and/or in connection with one or more other processes described elsewhere herein.

In a first aspect, process 1300 includes determining the K CMRs based at least in part on one or more of a standard predefinition, a network node pre-configuration, or a dynamic indication from the network node.

In a second aspect, alone or in combination with the first aspect, process 1300 includes determining the K CMRs based at least in part on remaining strongest CMRs that are not included in the set of CMRs associated with the P/SP CSI report.

In a third aspect, alone or in combination with one or more of the first and second aspects, process 1300 includes determining the K CMRs based at least in part on remaining weakest CMRs that are not included in the set of CMRs associated with the P/SP CSI report.

In a fourth aspect, alone or in combination with one or more of the first through third aspects, process 1300 includes determining the K CMRs based at least in part on remaining CMRs, within a certain RSRP/SINR range, that are not included in the set of CMRs associated with the P/SP CSI report.

In a fifth aspect, alone or in combination with one or more of the first through fourth aspects, process 1300 includes determining the K CMRs based at least in part on a plurality of remaining CMRs that are not included in the set of CMRs associated with the P/SP CSI report.

In a sixth aspect, alone or in combination with one or more of the first through fifth aspects, process 1300 includes determining the K CMRs based at least in part on an indication in the request for the AP CSI report that indicates CMR identifiers associated with the K CMRs.

In a seventh aspect, alone or in combination with one or more of the first through sixth aspects, the L1-RSRP/SINR measurements of the K CMRs are quantized L1-RSRP/SINR measurements, wherein the quantized L1-RSRP/SINR measurements are based at least in part on a differential quantization or an absolute quantization with respect to a strongest or weakest L1-RSRP/SINR measurement of a set of L1-RSRP/SINR measurements associated with the set of CMRs, and a quantization is based at least in part on one or more of a standard predefinition, a network node pre-configuration, or a dynamic indication from the network node via the request for the AP CSI report.

In an eighth aspect, alone or in combination with one or more of the first through seventh aspects, process 1300 includes receiving, from the network node, a CSI report configuration that indicates a CSI report setting identifier associated with the P/SP CSI report, a determination scheme associated with the K CMRs, and a quantization scheme associated with the L1-RSRP/SINR measurements of K CMRs.

In a ninth aspect, alone or in combination with one or more of the first through eighth aspects, process 1300 includes receiving, from the network node, a CSI report configuration that indicates a CSI report setting identifier associated with the P/SP CSI report, wherein receiving the request for the AP CSI report comprises receiving an uplink grant DCI that indicates the request for the AP CSI report, wherein the uplink grant DCI includes one or more dedicated fields to indicate a determination scheme associated with the K CMRs and a quantization scheme associated with the L1-RSRP/SINR measurements of K CMRs.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., base station 110) performs operations associated with time domain beam prediction using CSI reporting.

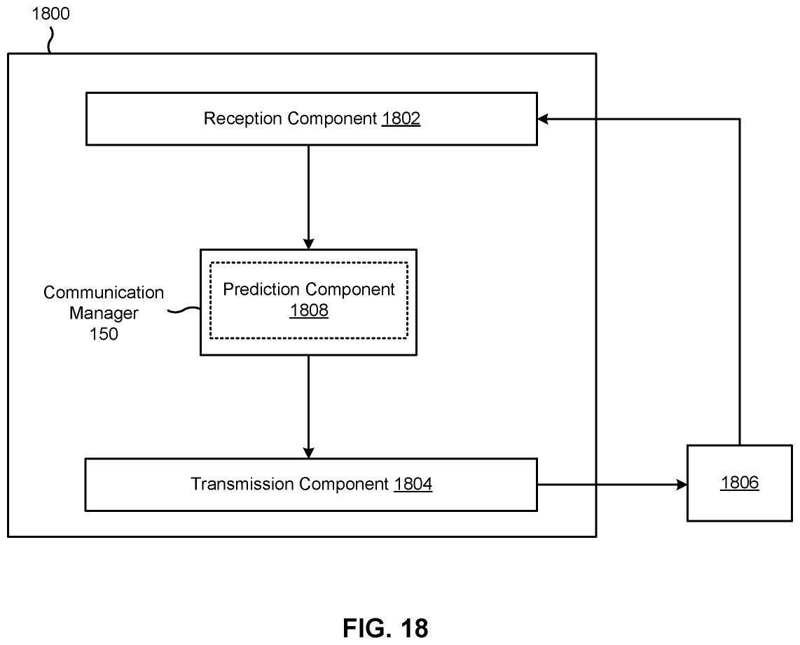

As shown in FIG. 14, in some aspects, process 1400 may include receiving, from a UE, a P/SP CSI report that indicates an L1-RSRP/SINR measurement for each of a set of CMRs (block 1410). For example, the network node (e.g., using communication manager 150 and/or reception component 1802, depicted in FIG. 18) may receive, from a UE, a P/SP CSI report that indicates an L1-RSRP/SINR measurement for each of a set of CMRs, as described above.

As further shown in FIG. 14, in some aspects, process 1400 may include transmitting, to the UE, a request for an AP CSI report (block 1420). For example, the network node (e.g., using communication manager 150 and/or transmission component 1804, depicted in FIG. 18) may transmit, to the UE, a request for an AP CSI report, as described above.

As further shown in FIG. 14, in some aspects, process 1400 may include receiving, from the UE, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report (block 1430). For example, the network node (e.g., using communication manager 150 and/or reception component 1802, depicted in FIG. 18) may receive, from the UE, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report, as described above.

Process 1400 may include additional aspects, such as any single aspect or any combination of aspects described below and/or in connection with one or more other processes described elsewhere herein.

In a first aspect, the K CMRs is based at least in part on one or more of a standard predefinition, a network node pre-configuration, or a dynamic indication from the network node, the K CMRs is based at least in part on remaining strongest CMRs that are not included in the set of CMRs associated with the P/SP CSI report, the K CMRs is based at least in part on remaining weakest CMRs that are not included in the set of CMRs associated with the P/SP CSI report, the K CMRs is based at least in part on remaining CMRs, within a certain RSRP/SINR range, that are not included in the set of CMRs associated with the P/SP CSI report, the K CMRs is based at least in part on a plurality of remaining CMRs that are not included in the set of CMRs associated with the P/SP CSI report, or the K CMRs is based at least in part on an indication in the request for the AP CSI report that indicates CMR identifiers associated with the K CMRs.

In a second aspect, alone or in combination with the first aspect, the L1-RSRP/SINR measurements of the K CMRs are quantized L1-RSRP/SINR measurements, and the quantized L1-RSRP/SINR measurements are based at least in part on a differential quantization or an absolute quantization with respect to a strongest or weakest L1-RSRP/SINR measurement of a set of L1-RSRP/SINR measurements associated with the set of CMRs.

In a third aspect, alone or in combination with one or more of the first and second aspects, process 1400 includes transmitting, to the UE, a CSI report configuration that indicates a CSI report setting identifier associated with the P/SP CSI report, a determination scheme associated with the K CMRs, and a quantization scheme associated with the L1-RSRP/SINR measurements of K CMRs.

In a fourth aspect, alone or in combination with one or more of the first through third aspects, process 1400 includes transmitting, to the UE, a CSI report configuration that indicates a CSI report setting identifier associated with the P/SP CSI report, wherein transmitting the request for the AP CSI report comprises transmitting an uplink grant DCI that indicates the request for the AP CSI report, wherein the uplink grant DCI includes one or more dedicated fields to indicate a determination scheme associated with the K CMRs and a quantization scheme associated with the L1-RSRP/SINR measurements of K CMRs.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a UE, in accordance with the present disclosure. Example process 1500 is an example where the UE (e.g., UE 120) performs operations associated with time domain beam prediction using CSI reporting.

As shown in FIG. 15, in some aspects, process 1500 may include receiving, from a network node, a CSI report configuration (block 1510). For example, the UE (e.g., using communication manager 140 and/or reception component 1702, depicted in FIG. 17) may receive, from a network node, a CSI report configuration, as described above.

As further shown in FIG. 15, in some aspects, process 1500 may include transmitting, to the network node and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs, and a time domain beam prediction is based at least in part on the CSI report (block 1520). For example, the UE (e.g., using communication manager 140 and/or transmission component 1704, depicted in FIG. 17) may transmit, to the network node and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs, and a time domain beam prediction is based at least in part on the CSI report, as described above.

Process 1500 may include additional aspects, such as any single aspect or any combination of aspects described below and/or in connection with one or more other processes described elsewhere herein.

In a first aspect, the quantized CMR-common L1-RSRP/SINR measurement is applicable to the multiple K1 CMRs and approximates actual CMR-common L1-RSRP/SINR measurements of respective K1 CMRs.

In a second aspect, alone or in combination with the first aspect, process 1500 includes determining the K1 CMRs based at least in part on a difference between N total CMRs and the K CMRs.

In a third aspect, alone or in combination with one or more of the first and second aspects, process 1500 includes determining the K1 CMRs based at least in part on multiple preconfigured CMR subsets, wherein the quantized CMR-common L1-RSRP/SINR measurement is for a CMR subset of the multiple preconfigured CMR subsets, and the quantized CMR-common L1-RSRP/SINR measurement excludes the explicit L1-RSRP/SINR measurement for each of the K CMRs.

In a fourth aspect, alone or in combination with one or more of the first through third aspects, process 1500 includes determining the K1 CMRs based at least in part on multiple CMR subset pre-groupings, wherein each CMR subset pre-grouping of the multiple CMR subset pre-groupings is associated with a quantity of subsets and a quantity of CMRs within each subset, and the multiple CMR subset pre-groupings are indicated in the CSI resource setting associated with the CSI report.

In a fifth aspect, alone or in combination with one or more of the first through fourth aspects, process 1500 includes determining the quantized CMR-common L1-RSRP/SINR measurement based at least in part on a quantization metric, wherein the quantization metric is based at least in part on one or more of a standard predefinition, a network node pre-configuration, a dynamic indication from the network node, or a UE report.

In a sixth aspect, alone or in combination with one or more of the first through fifth aspects, the quantized CMR-common L1-RSRP/SINR measurement is differentially quantized with respect to the explicit L1-RSRP/SINR measurement, wherein the explicit L1-RSRP/SINR measurement is a strongest explicit L1-RSRP/SINR measurement or a weakest explicit L1-RSRP/SINR measurement of K explicit L1-RSRP/SINR measurements, and a quantity of bits associated with the quantized CMR-common L1-RSRP/SINR measurement is greater than a quantity of bits associated with the explicit L1-RSRP/SINR measurement.

In a seventh aspect, alone or in combination with one or more of the first through sixth aspects, process 1500 includes transmitting, to the network node, an indication of a subset identifier associated with a strongest quantized CMR-common L1-RSRP/SINR measurement of multiple quantized CMR-common L1-RSRP/SINR measurements associated with respective CMR subsets.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a network node, in accordance with the present disclosure. Example process 1600 is an example where the network node (e.g., base station 110) performs operations associated with time domain beam prediction using CSI reporting.

As shown in FIG. 16, in some aspects, process 1600 may include transmitting, to a UE, a CSI report configuration (block 1610). For example, the network node (e.g., using communication manager 150 and/or transmission component 1804, depicted in FIG. 18) may transmit, to a UE, a CSI report configuration, as described above.

As further shown in FIG. 16, in some aspects, process 1600 may include receiving, from the UE and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs (block 1620). For example, the network node (e.g., using communication manager 150 and/or reception component 1802, depicted in FIG. 18) may receive, from the UE and based at least in part on the CSI report configuration, a CSI report that indicates: an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs, as described above.

As further shown in FIG. 16, in some aspects, process 1600 may include performing a time domain beam prediction based at least in part the CSI report (block 1630). For example, the network node (e.g., using communication manager 150 and/or prediction component 1808, depicted in FIG. 18) may perform a time domain beam prediction based at least in part the CSI report, as described above.

Process 1600 may include additional aspects, such as any single aspect or any combination of aspects described below and/or in connection with one or more other processes described elsewhere herein.

In a first aspect, the K1 CMRs is based at least in part on a difference between N total CMRs and the K CMRs.

In a second aspect, alone or in combination with the first aspect, the K1 CMRs is based at least in part on multiple preconfigured CMR subsets, wherein the quantized CMR-common L1-RSRP/SINR measurement is for a CMR subset of the multiple preconfigured CMR subsets, and the quantized CMR-common L1-RSRP/SINR measurement excludes the explicit L1-RSRP/SINR measurement for each of the K CMRs.

In a third aspect, alone or in combination with one or more of the first and second aspects, the K1 CMRs is based at least in part on multiple CMR subset pre-groupings, wherein each CMR subset pre-grouping of the multiple CMR subset pre-groupings is associated with a quantity of subsets and a quantity of CMRs within each subset, and the multiple CMR subset pre-groupings are indicated in the CSI resource setting associated with the CSI report.

In a fourth aspect, alone or in combination with one or more of the first through third aspects, the quantized CMR-common L1-RSRP/SINR measurement is based at least in part on a quantization metric, and the quantization metric is based at least in part on one or more of a standard predefinition, a network node pre-configuration, a dynamic indication from the network node, or a UE report.

In a fifth aspect, alone or in combination with one or more of the first through fourth aspects, the quantized CMR-common L1-RSRP/SINR measurement is differentially quantized with respect to the explicit L1-RSRP/SINR measurement, wherein the explicit L1-RSRP/SINR measurement is a strongest explicit L1-RSRP/SINR measurement or a weakest explicit L1-RSRP/SINR measurement of K explicit L1-RSRP/SINR measurements, and a quantity of bits associated with the quantized CMR-common L1-RSRP/SINR measurement is greater than a quantity of bits associated with the explicit L1-RSRP/SINR measurement.

In a sixth aspect, alone or in combination with one or more of the first through fifth aspects, process 1600 includes receiving, from the UE, an indication of a subset identifier associated with a strongest quantized CMR-common L1-RSRP/SINR measurement of multiple quantized CMR-common L1-RSRP/SINR measurements associated with respective CMR subsets.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram of an example apparatus 1700 for wireless communication. The apparatus 1700 may be a UE, or a UE may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 140. The communication manager 140 may include one or more of a determination component 1708, among other examples.

In some aspects, the apparatus 1700 may be configured to perform one or more operations described herein in connection with FIGS. 7-12. Additionally, or alternatively, the apparatus 1700 may be configured to perform one or more processes described herein, such as process 1300 of FIG. 13, process 1500 of FIG. 15, or a combination thereof. In some aspects, the apparatus 1700 and/or one or more components shown in FIG. 17 may include one or more components of the UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the UE described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the UE described in connection with FIG. 2. In some aspects, the transmission component 1704 may be co-located with the reception component 1702 in a transceiver.

The transmission component 1704 may transmit, to a network node, a P/SP CSI report that indicates an L1-RSRP/SINR measurement for each of a set of CMRs. The reception component 1702 may receive, from the network node, a request for an AP CSI report. The transmission component 1704 may transmit, to the network node, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report.

The determination component 1708 may determine the K CMRs based at least in part on one or more of: a standard predefinition, a network node pre-configuration, or a dynamic indication from the network node. The determination component 1708 may determine the K CMRs based at least in part on remaining strongest CMRs that are not included in the set of CMRs associated with the P/SP CSI report. The determination component 1708 may determine the K CMRs based at least in part on remaining weakest CMRs that are not included in the set of CMRs associated with the P/SP CSI report. The determination component 1708 may determine the K CMRs based at least in part on remaining CMRs, within a certain RSRP/SINR range, that are not included in the set of CMRs associated with the P/SP CSI report. The determination component 1708 may determine the K CMRs based at least in part on a plurality of remaining CMRs that are not included in the set of CMRs associated with the P/SP CSI report. The determination component 1708 may determine the K CMRs based at least in part on an indication in the request for the AP CSI report that indicates CMR identifiers associated with the K CMRs.

The reception component 1702 may receive, from the network node, a CSI report configuration that indicates a CSI report setting identifier associated with the P/SP CSI report, a determination scheme associated with the K CMRs, and a quantization scheme associated with the L1-RSRP/SINR measurements of K CMRs. The reception component 1702 may receive, from the network node, a CSI report configuration that indicates a CSI report setting identifier associated with the P/SP CSI report wherein receiving the request for the AP CSI report comprises receiving an uplink grant DCI that indicates the request for the AP CSI report, wherein the uplink grant DCI includes one or more dedicated fields to indicate a determination scheme associated with the K CMRs and a quantization scheme associated with the L1-RSRP/SINR measurements of K CMRs.

The reception component 1702 may receive, from a network node, a CSI report configuration. The transmission component 1704 may transmit, to the network node and based at least in part on the CSI report configuration, a CSI report that indicates an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, wherein the K1 CMRs are different than the K CMRs, and a time domain beam prediction is based at least in part on the CSI report.

The determination component 1708 may determine the K1 CMRs based at least in part on a difference between N total CMRs and the K CMRs. The determination component 1708 may determine the K1 CMRs based at least in part on multiple preconfigured CMR subsets, wherein the quantized CMR-common L1-RSRP/SINR measurement is for a CMR subset of the multiple preconfigured CMR subsets, and the quantized CMR-common L1-RSRP/SINR measurement excludes the explicit L1-RSRP/SINR measurement for each of the K CMRs. The determination component 1708 may determine the K1 CMRs based at least in part on multiple CMR subset pre-groupings, wherein each CMR subset pre-grouping of the multiple CMR subset pre-groupings is associated with a quantity of subsets and a quantity of CMRs within each subset, and the multiple CMR subset pre-groupings are indicated in the CSI resource setting associated with the CSI report.

The determination component 1708 may determine the quantized CMR-common L1-RSRP/SINR measurement based at least in part on a quantization metric, wherein the quantization metric is based at least in part on one or more of: a standard predefinition, a network node pre-configuration, a dynamic indication from the network node, or a UE report. The transmission component 1704 may transmit, to the network node, an indication of a subset identifier associated with a strongest quantized CMR-common L1-RSRP/SINR measurement of multiple quantized CMR-common L1-RSRP/SINR measurements associated with respective CMR subsets.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication. The apparatus 1800 may be a network node, or a network node may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a base station, or another wireless communication device) using the reception component 1802 and the transmission component 1804. As further shown, the apparatus 1800 may include the communication manager 150. The communication manager 150 may include a prediction component 1808, among other examples.

In some aspects, the apparatus 1800 may be configured to perform one or more operations described herein in connection with FIGS. 7-12. Additionally, or alternatively, the apparatus 1800 may be configured to perform one or more processes described herein, such as process 1400 of FIG. 14, process 1600 of FIG. 16, or a combination thereof. In some aspects, the apparatus 1800 and/or one or more components shown in FIG. 18 may include one or more components of the network node described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the network node described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the network node described in connection with FIG. 2. In some aspects, the transmission component 1804 may be co-located with the reception component 1802 in a transceiver.

The reception component 1802 may receive, from a UE, a P/SP CSI report that indicates an L1-RSRP/SINR measurement for each of a set of CMRs. The transmission component 1804 may transmit, to the UE, a request for an AP CSI report. The reception component 1802 may receive, from the UE, the AP CSI report based at least in part on the request, wherein the AP CSI report indicates L1-RSRP/SINR measurements of K CMRs, wherein the K CMRs are separate from the set of CMRs associated with the P/SP CSI report, and a time domain beam prediction is based at least in part on the AP CSI report.

The transmission component 1804 may transmit, to the UE, a CSI report configuration that indicates a CSI report setting identifier associated with the P/SP CSI report, a determination scheme associated with the K CMRs, and a quantization scheme associated with the L1-RSRP/SINR measurements of K CMRs. The transmission component 1804 may transmit, to the UE, a CSI report configuration that indicates a CSI report setting identifier associated with the P/SP CSI report wherein transmitting the request for the AP CSI report comprises transmitting an uplink grant DCI that indicates the request for the AP CSI report, wherein the uplink grant DCI includes one or more dedicated fields to indicate a determination scheme associated with the K CMRs and a quantization scheme associated with the L1-RSRP/SINR measurements of K CMRs.

The transmission component 1804 may transmit, to a UE, a CSI report configuration. The reception component 1802 may receive, from the UE and based at least in part on the CSI report configuration, a CSI report that indicates an explicit L1-RSRP/SINR measurement for each of K CMRs, wherein the K CMRs are configured by a CSI resource setting associated with the CSI report; and a quantized CMR-common L1-RSRP/SINR measurement associated with multiple K1 CMRs, and the K1 CMRs are different than the K CMRs. The prediction component 1808 may perform a time domain beam prediction based at least in part the CSI report. The reception component 1802 may receive, from the UE, an indication of a subset identifier associated with a strongest quantized CMR-common L1-RSRP/SINR measurement of multiple quantized CMR-common L1-RSRP/SINR measurements associated with respective CMR subsets.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

The following provides an overview of some Aspects of the present disclosure:

Aspect 1: A method of wireless communication performed by a user equipment (UE), comprising: transmitting, to a network node, a periodic or semi-persistent (P/SP) channel state information (CSI) report that indicates a layer 1 (L1) reference signal received power (RSRP) or signal-to-interference-plus-noise ratio (SINR) (L1-RSRP/SINR) measurement for each of a set of channel measurement resources (CMRs); receiving, from the network node, a request for an aperiodic (AP) CSI report; and transmitting, to the network node, the AP CSI report based at least in part on the request, wherein the AP CSI report indicates L1-RSRP/SINR measurements of K CMRs, wherein the K CMRs are separate from the set of CMRs associated with the P/SP CSI report, and wherein a time domain beam prediction is based at least in part on the AP CSI report.

Aspect 2: The method of Aspect 1, further comprising: determining the K CMRs based at least in part on one or more of: a standard predefinition, a network node pre-configuration, or a dynamic indication from the network node.

Aspect 3: The method of any of Aspects 1 through 2, further comprising: determining the K CMRs based at least in part on remaining strongest CMRs that are not included in the set of CMRs associated with the P/SP CSI report.

Aspect 4: The method of any of Aspects 1 through 3, further comprising: determining the K CMRs based at least in part on remaining weakest CMRs that are not included in the set of CMRs associated with the P/SP CSI report.

Aspect 5: The method of any of Aspects 1 through 4, further comprising: determining the K CMRs based at least in part on remaining CMRs, within a certain RSRP/SINR range, that are not included in the set of CMRs associated with the P/SP CSI report.

Aspect 6: The method of any of Aspects 1 through 5, further comprising: determining the K CMRs based at least in part on a plurality of remaining CMRs that are not included in the set of CMRs associated with the P/SP CSI report.

Aspect 7: The method of any of Aspects 1 through 6, further comprising: determining the K CMRs based at least in part on an indication in the request for the AP CSI report that indicates CMR identifiers associated with the K CMRs.

Aspect 8: The method of any of Aspects 1 through 7, wherein the L1-RSRP/SINR measurements of the K CMRs are quantized L1-RSRP/SINR measurements, wherein the quantized L1-RSRP/SINR measurements are based at least in part on a differential quantization or an absolute quantization with respect to a strongest or weakest L1-RSRP/SINR measurement of a set of L1-RSRP/SINR measurements associated with the set of CMRs, and wherein a quantization is based at least in part on one or more of: a standard predefinition, a network node pre-configuration, or a dynamic indication from the network node via the request for the AP CSI report.

Aspect 9: The method of any of Aspects 1 through 8, further comprising: receiving, from the network node, a CSI report configuration that indicates a CSI report setting identifier associated with the P/SP CSI report, a determination scheme associated with the K CMRs, and a quantization scheme associated with the L1-RSRP/SINR measurements of K CMRs.

Aspect 10: The method of any of Aspects 1 through 9, further comprising: receiving, from the network node, a CSI report configuration that indicates a CSI report setting identifier associated with the P/SP CSI report, wherein receiving the request for the AP CSI report comprises receiving an uplink grant downlink control information (DCI) that indicates the request for the AP CSI report, wherein the uplink grant DCI includes one or more dedicated fields to indicate a determination scheme associated with the K CMRs and a quantization scheme associated with the L1-RSRP/SINR measurements of K CMRs.

Aspect 11: A method of wireless communication performed by a network node, comprising: receiving, from a user equipment (UE), a periodic or semi-persistent (P/SP) channel state information (CSI) report that indicates a layer 1 (L1) reference signal received power (RSRP) or signal-to-interference-plus-noise ratio (SINR) (L1-RSRP/SINR) measurement for each of a set of channel measurement resources (CMRs); transmitting, to the UE, a request for an aperiodic (AP) CSI report; and receiving, from the UE, the AP CSI report based at least in part on the request, wherein the AP CSI report indicates L1-RSRP/SINR measurements of K CMRs, wherein the K CMRs are separate from the set of CMRs associated with the P/SP CSI report, and wherein a time domain beam prediction is based at least in part on the AP CSI report.

Aspect 12: The method of Aspect 11, wherein: the K CMRs is based at least in part on one or more of: a standard predefinition, a network node pre-configuration, or a dynamic indication from the network node; the K CMRs is based at least in part on remaining strongest CMRs that are not included in the set of CMRs associated with the P/SP CSI report; the K CMRs is based at least in part on remaining weakest CMRs that are not included in the set of CMRs associated with the P/SP CSI report; the K CMRs is based at least in part on remaining CMRs, within a certain RSRP/SINR range, that are not included in the set of CMRs associated with the P/SP CSI report; the K CMRs is based at least in part on a plurality of remaining CMRs that are not included in the set of CMRs associated with the P/SP CSI report; or the K CMRs is based at least in part on an indication in the request for the AP CSI report that indicates CMR identifiers associated with the K CMRs.

Aspect 13: The method of any of Aspects 11 through 12, wherein the L1-RSRP/SINR measurements of the K CMRs are quantized L1-RSRP/SINR measurements, and wherein the quantized L1-RSRP/SINR measurements are based at least in part on a differential quantization or an absolute quantization with respect to a strongest or weakest L1-RSRP/SINR measurement of a set of L1-RSRP/SINR measurements associated with the set of CMRs.

Aspect 14: The method of any of Aspects 11 through 13, further comprising: transmitting, to the UE, a CSI report configuration that indicates a CSI report setting identifier associated with the P/SP CSI report, a determination scheme associated with the K CMRs, and a quantization scheme associated with the L1-RSRP/SINR measurements of K CMRs.

Aspect 15: The method of any of Aspects 11 through 14, further comprising: transmitting, to the UE, a CSI report configuration that indicates a CSI report setting identifier associated with the P/SP CSI report, wherein transmitting the request for the AP CSI report comprises transmitting an uplink grant downlink control information (DCI) that indicates the request for the AP CSI report, wherein the uplink grant DCI includes one or more dedicated fields to indicate a determination scheme associated with the K CMRs and a quantization scheme associated with the L1-RSRP/SINR measurements of K CMRs.

Aspect 16: A method of wireless communication performed by a user equipment (UE), comprising: receiving, from a network node, a channel state information (CSI) report configuration; and transmitting, to the network node and based at least in part on the CSI report configuration, a CSI report that indicates: an explicit layer 1 (L1) reference signal received power (RSRP) or signal-to-interference-plus-noise ratio (SINR) (L1-RSRP/SINR) measurement for each of K channel measurement resources (CMRs), wherein the K CMRs are configured by a CSI resource setting associated with the CSI report; and a quantized CMR-common L1-RSRP/SINR measurement associated with multiple K1 CMRs, wherein the K1 CMRs are different than the K CMRs, wherein a time domain beam prediction is based at least in part on the CSI report.

Aspect 17: The method of Aspect 16, wherein the quantized CMR-common L1-RSRP/SINR measurement is applicable to the multiple K1 CMRs and approximates actual CMR-common L1-RSRP/SINR measurements of respective K1 CMRs.

Aspect 18: The method of any of Aspects 16 through 17, further comprising: determining the K1 CMRs based at least in part on a difference between N total CMRs and the K CMRs.

Aspect 19: The method of any of Aspects 16 through 18, further comprising: determining the K1 CMRs based at least in part on multiple preconfigured CMR subsets, wherein the quantized CMR-common L1-RSRP/SINR measurement is for a CMR subset of the multiple preconfigured CMR subsets, and wherein the quantized CMR-common L1-RSRP/SINR measurement excludes the explicit L1-RSRP/SINR measurement for each of the K CMRs.

Aspect 20: The method of any of Aspects 16 through 19, further comprising: determining the K1 CMRs based at least in part on multiple CMR subset pre-groupings, wherein each CMR subset pre-grouping of the multiple CMR subset pre-groupings is associated with a quantity of subsets and a quantity of CMRs within each subset, and wherein the multiple CMR subset pre-groupings are indicated in the CSI resource setting associated with the CSI report.

Aspect 21: The method of any of Aspects 16 through 20, further comprising: determining the quantized CMR-common L1-RSRP/SINR measurement based at least in part on a quantization metric, wherein the quantization metric is based at least in part on one or more of: a standard predefinition, a network node pre-configuration, a dynamic indication from the network node, or a UE report.

Aspect 22: The method of any of Aspects 16 through 21, wherein the quantized CMR-common L1-RSRP/SINR measurement is differentially quantized with respect to the explicit L1-RSRP/SINR measurement, wherein the explicit L1-RSRP/SINR measurement is a strongest explicit L1-RSRP/SINR measurement or a weakest explicit L1-RSRP/SINR measurement of K explicit L1-RSRP/SINR measurements, and wherein a quantity of bits associated with the quantized CMR-common L1-RSRP/SINR measurement is greater than a quantity of bits associated with the explicit L1-RSRP/SINR measurement.

Aspect 23: The method of any of Aspects 16 through 22, further comprising: transmitting, to the network node, an indication of a subset identifier associated with a strongest quantized CMR-common L1-RSRP/SINR measurement of multiple quantized CMR-common L1-RSRP/SINR measurements associated with respective CMR subsets.

Aspect 24: A method of wireless communication performed by a network node, comprising: transmitting, to a user equipment (UE), a channel state information (CSI) report configuration; receiving, from the UE and based at least in part on the CSI report configuration, a CSI report that indicates: an explicit layer 1 (L1) reference signal received power (RSRP) or signal-to-interference-plus-noise ratio (SINR) (L1-RSRP/SINR) measurement for each of K channel measurement resources (CMRs), wherein the K CMRs are configured by a CSI resource setting associated with the CSI report; and a quantized CMR-common L1-RSRP/SINR measurement associated with multiple K1 CMRs, wherein the K1 CMRs are different than the K CMRs; and performing a time domain beam prediction based at least in part the CSI report.

Aspect 25: The method of Aspect 24, wherein the K1 CMRs is based at least in part on a difference between N total CMRs and the K CMRs.

Aspect 26: The method of any of Aspects 24 through 25, wherein the K1 CMRs is based at least in part on multiple preconfigured CMR subsets, wherein the quantized CMR-common L1-RSRP/SINR measurement is for a CMR subset of the multiple preconfigured CMR subsets, and wherein the quantized CMR-common L1-RSRP/SINR measurement excludes the explicit L1-RSRP/SINR measurement for each of the K CMRs.

Aspect 27: The method of any of Aspects 24 through 26, wherein the K1 CMRs is based at least in part on multiple CMR subset pre-groupings, wherein each CMR subset pre-grouping of the multiple CMR subset pre-groupings is associated with a quantity of subsets and a quantity of CMRs within each subset, and wherein the multiple CMR subset pre-groupings are indicated in the CSI resource setting associated with the CSI report.

Aspect 28: The method of any of Aspects 24 through 27, wherein the quantized CMR-common L1-RSRP/SINR measurement is based at least in part on a quantization metric, and wherein the quantization metric is based at least in part on one or more of: a standard predefinition, a network node pre-configuration, a dynamic indication from the network node, or a UE report.

Aspect 29: The method of any of Aspects 24 through 28, wherein the quantized CMR-common L1-RSRP/SINR measurement is differentially quantized with respect to the explicit L1-RSRP/SINR measurement, wherein the explicit L1-RSRP/SINR measurement is a strongest explicit L1-RSRP/SINR measurement or a weakest explicit L1-RSRP/SINR measurement of K explicit L1-RSRP/SINR measurements, and wherein a quantity of bits associated with the quantized CMR-common L1-RSRP/SINR measurement is greater than a quantity of bits associated with the explicit L1-RSRP/SINR measurement.

Aspect 30: The method of any of Aspects 24 through 29, further comprising: receiving, from the UE, an indication of a subset identifier associated with a strongest quantized CMR-common L1-RSRP/SINR measurement of multiple quantized CMR-common L1-RSRP/SINR measurements associated with respective CMR subsets.

Aspect 31: An apparatus for wireless communication at a device, comprising a processor; memory coupled with the processor; and instructions stored in the memory and executable by the processor to cause the apparatus to perform the method of one or more of Aspects 1-10 or Aspects 16-23.

Aspect 32: A device for wireless communication, comprising a memory and one or more processors coupled to the memory, the one or more processors configured to perform the method of one or more of Aspects 1-10 or Aspects 16-23.

Aspect 33: An apparatus for wireless communication, comprising at least one means for performing the method of one or more of Aspects 1-10 or Aspects 16-23.

Aspect 34: A non-transitory computer-readable medium storing code for wireless communication, the code comprising instructions executable by a processor to perform the method of one or more of Aspects 1-10 or Aspects 16-23.

Aspect 35: A non-transitory computer-readable medium storing a set of instructions for wireless communication, the set of instructions comprising one or more instructions that, when executed by one or more processors of a device, cause the device to perform the method of one or more of Aspects 1-10 or Aspects 16-23.

Aspect 36: An apparatus for wireless communication at a device, comprising a processor; memory coupled with the processor; and instructions stored in the memory and executable by the processor to cause the apparatus to perform the method of one or more of Aspects 11-15 or Aspects 24-30.

Aspect 37: A device for wireless communication, comprising a memory and one or more processors coupled to the memory, the one or more processors configured to perform the method of one or more of Aspects 11-15 or Aspects 24-30.

Aspect 38: An apparatus for wireless communication, comprising at least one means for performing the method of one or more of Aspects 11-15 or Aspects 24-30.

Aspect 39: A non-transitory computer-readable medium storing code for wireless communication, the code comprising instructions executable by a processor to perform the method of one or more of Aspects 11-15 or Aspects 24-30.

Aspect 40: A non-transitory computer-readable medium storing a set of instructions for wireless communication, the set of instructions comprising one or more instructions that, when executed by one or more processors of a device, cause the device to perform the method of one or more of Aspects 11-15 or Aspects 24-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
transmit, to a network node, a periodic or semi-persistent (P/SP) channel state information (CSI) report that indicates a layer 1 (L1) reference signal received power (RSRP) or signal-to-interference-plus-noise ratio (SINR) (L1-RSRP/SINR) measurement for each of a set of channel measurement resources (CMRs);
receive, from the network node, a request for an aperiodic (AP) CSI report; and
transmit, to the network node, the AP CSI report based at least in part on the request, wherein the AP CSI report indicates L1-RSRP/SINR measurements of K CMRs, wherein the K CMRs are separate from the set of CMRs associated with the P/SP CSI report, and wherein a time domain beam prediction is based at least in part on the AP CSI report.

2. The apparatus of claim 1, wherein the one or more processors are further configured to:
determine the K CMRs based at least in part on one or more of: a standard predefinition, a network node pre-configuration, or a dynamic indication from the network node.

3. The apparatus of claim 1, wherein the one or more processors are further configured to:
determine the K CMRs based at least in part on remaining strongest CMRs that are not included in the set of CMRs associated with the P/SP CSI report.

4. The apparatus of claim 1, wherein the one or more processors are further configured to:
determine the K CMRs based at least in part on remaining weakest CMRs that are not included in the set of CMRs associated with the P/SP CSI report.

5. The apparatus of claim 1, wherein the one or more processors are further configured to:
determine the K CMRs based at least in part on remaining CMRs, within a certain RSRP/SINR range, that are not included in the set of CMRs associated with the P/SP CSI report.

6. The apparatus of claim 1, wherein the one or more processors are further configured to:
determine the K CMRs based at least in part on a plurality of remaining CMRs that are not included in the set of CMRs associated with the P/SP CSI report.

7. The apparatus of claim 1, wherein the one or more processors are further configured to:
determine the K CMRs based at least in part on an indication in the request for the AP CSI report that indicates CMR identifiers associated with the K CMRs.

8. The apparatus of claim 1, wherein the L1-RSRP/SINR measurements of the K CMRs are quantized L1-RSRP/SINR measurements, wherein the quantized L1-RSRP/SINR measurements are based at least in part on a differential quantization or an absolute quantization with respect to a strongest or weakest L1-RSRP/SINR measurement of a set of L1-RSRP/SINR measurements associated with the set of CMRs, and wherein a quantization is based at least in part on one or more of: a standard predefinition, a network node pre-configuration, or a dynamic indication from the network node via the request for the AP CSI report.

9. The apparatus of claim 1, wherein the one or more processors are further configured to:
receive, from the network node, a CSI report configuration that indicates a CSI report setting identifier associated with the P/SP CSI report, a determination scheme associated with the K CMRs, and a quantization scheme associated with the L1-RSRP/SINR measurements of K CMRs.

10. The apparatus of claim 1, wherein the one or more processors are further configured to:
receive, from the network node, a CSI report configuration that indicates a CSI report setting identifier associated with the P/SP CSI report,
wherein receiving the request for the AP CSI report comprises receiving an uplink grant downlink control information (DCI) that indicates the request for the AP CSI report, wherein the uplink grant DCI includes one or more dedicated fields to indicate a determination scheme associated with the K CMRs and a quantization scheme associated with the L1-RSRP/SINR measurements of K CMRs.

11. An apparatus for wireless communication at a network node, comprising:
a memory; and
one or more processors, coupled to the memory, configured to:
receive, from a user equipment (UE), a periodic or semi-persistent (P/SP) channel state information (CSI) report that indicates a layer 1 (L1) reference signal received power (RSRP) or signal-to-interference-plus-noise ratio (SINR) (L1-RSRP/SINR) measurement for each of a set of channel measurement resources (CMRs);
transmit, to the UE, a request for an aperiodic (AP) CSI report; and
receive, from the UE, the AP CSI report based at least in part on the request, wherein the AP CSI report indicates L1-RSRP/SINR measurements of K CMRs, wherein the K CMRs are separate from the set of CMRs associated with the P/SP CSI report, and wherein a time domain beam prediction is based at least in part on the AP CSI report.

12. The apparatus of claim 11, wherein:
the K CMRs is based at least in part on one or more of: a standard predefinition, a network node pre-configuration, or a dynamic indication from the network node;
the K CMRs is based at least in part on remaining strongest CMRs that are not included in the set of CMRs associated with the P/SP CSI report;
the K CMRs is based at least in part on remaining weakest CMRs that are not included in the set of CMRs associated with the P/SP CSI report;
the K CMRs is based at least in part on remaining CMRs, within a certain RSRP/SINR range, that are not included in the set of CMRs associated with the P/SP CSI report;
the K CMRs is based at least in part on a plurality of remaining CMRs that are not included in the set of CMRs associated with the P/SP CSI report; or
the K CMRs is based at least in part on an indication in the request for the AP CSI report that indicates CMR identifiers associated with the K CMRs.

13. The apparatus of claim 11, wherein the L1-RSRP/SINR measurements of the K CMRs are quantized L1-RSRP/SINR measurements, and wherein the quantized L1-RSRP/SINR measurements are based at least in part on a differential quantization or an absolute quantization with respect to a strongest or weakest L1-RSRP/SINR measurement of a set of L1-RSRP/SINR measurements associated with the set of CMRs.

14. The apparatus of claim 11, wherein the one or more processors are further configured to:
transmit, to the UE, a CSI report configuration that indicates a CSI report setting identifier associated with the P/SP CSI report, a determination scheme associated with the K CMRs, and a quantization scheme associated with the L1-RSRP/SINR measurements of K CMRs.

15. The apparatus of claim 11, wherein the one or more processors are further configured to:
transmit, to the UE, a CSI report configuration that indicates a CSI report setting identifier associated with the P/SP CSI report,
wherein transmitting the request for the AP CSI report comprises transmitting an uplink grant downlink control information (DCI) that indicates the request for the AP CSI report, wherein the uplink grant DCI includes one or more dedicated fields to indicate a determination scheme associated with the K CMRs and a quantization scheme associated with the L1-RSRP/SINR measurements of K CMRs.

16. An apparatus for wireless communication at a user equipment (UE), comprising:
a memory; and
one or more processors, coupled to the memory, configured to:
receive, from a network node, a channel state information (CSI) report configuration; and
transmit, to the network node and based at least in part on the CSI report configuration, a CSI report that indicates:
an explicit layer 1 (L1) reference signal received power (RSRP) or signal-to-interference-plus-noise ratio (SINR) (L1-RSRP/SINR) measurement for each of K channel measurement resources (CMRs), wherein the K CMRs are configured by a CSI resource setting associated with the CSI report; and
a quantized CMR-common L1-RSRP/SINR measurement associated with multiple K1 CMRs, wherein the K1 CMRs are different than the K CMRs,
wherein a time domain beam prediction is based at least in part on the CSI report.

17. The apparatus of claim 16, wherein the quantized CMR-common L1-RSRP/SINR measurement is applicable to the multiple K1 CMRs and approximates actual CMR-common L1-RSRP/SINR measurements of respective K1 CMRs.

18. The apparatus of claim 16, wherein the one or more processors are further configured to:
determine the K1 CMRs based at least in part on a difference between N total CMRs and the K CMRs.

19. The apparatus of claim 16, wherein the one or more processors are further configured to:
determine the K1 CMRs based at least in part on multiple preconfigured CMR subsets, wherein the quantized CMR-common L1-RSRP/SINR measurement is for a CMR subset of the multiple preconfigured CMR subsets, and wherein the quantized CMR-common L1-RSRP/SINR measurement excludes the explicit L1-RSRP/SINR measurement for each of the K CMRs.

20. The apparatus of claim 16, wherein the one or more processors are further configured to:
determine the K1 CMRs based at least in part on multiple CMR subset pre-groupings, wherein each CMR subset pre-grouping of the multiple CMR subset pre-groupings is associated with a quantity of subsets and a quantity of CMRs within each subset, and wherein the multiple CMR subset pre-groupings are indicated in the CSI resource setting associated with the CSI report.

21. The apparatus of claim 16, wherein the one or more processors are further configured to:
determine the quantized CMR-common L1-RSRP/SINR measurement based at least in part on a quantization metric, wherein the quantization metric is based at least in part on one or more of: a standard predefinition, a network node pre-configuration, a dynamic indication from the network node, or a UE report.

22. The apparatus of claim 16, wherein the quantized CMR-common L1-RSRP/SINR measurement is differentially quantized with respect to the explicit L1-RSRP/SINR measurement, wherein the explicit L1-RSRP/SINR measurement is a strongest explicit L1-RSRP/SINR measurement or a weakest explicit L1-RSRP/SINR measurement of K explicit L1-RSRP/SINR measurements, and wherein a quantity of bits associated with the quantized CMR-common L1-RSRP/SINR measurement is greater than a quantity of bits associated with the explicit L1-RSRP/SINR measurement.

23. The apparatus of claim 16, wherein the one or more processors are further configured to:
transmit, to the network node, an indication of a subset identifier associated with a strongest quantized CMR-common L1-RSRP/SINR measurement of multiple quantized CMR-common L1-RSRP/SINR measurements associated with respective CMR subsets.

24. An apparatus for wireless communication at a network node, comprising:
a memory; and
one or more processors, coupled to the memory, configured to:
transmit, to a user equipment (UE), a channel state information (CSI) report configuration;
receive, from the UE and based at least in part on the CSI report configuration, a CSI report that indicates:
an explicit layer 1 (L1) reference signal received power (RSRP) or signal-to-interference-plus-noise ratio (SINR) (L1-RSRP/SINR) measurement for each of K channel measurement resources (CMRs), wherein the K CMRs are configured by a CSI resource setting associated with the CSI report; and
a quantized CMR-common L1-RSRP/SINR measurement associated with multiple K1 CMRs, wherein the K1 CMRs are different than the K CMRs; and
perform a time domain beam prediction based at least in part the CSI report.

25. The apparatus of claim 24, wherein the K1 CMRs is based at least in part on a difference between N total CMRs and the K CMRs.

26. The apparatus of claim 24, wherein the K1 CMRs is based at least in part on multiple preconfigured CMR subsets, wherein the quantized CMR-common L1-RSRP/SINR measurement is for a CMR subset of the multiple preconfigured CMR subsets, and wherein the quantized CMR-common L1-RSRP/SINR measurement excludes the explicit L1-RSRP/SINR measurement for each of the K CMRs.

27. The apparatus of claim 24, wherein the K1 CMRs is based at least in part on multiple CMR subset pre-groupings, wherein each CMR subset pre-grouping of the multiple CMR subset pre-groupings is associated with a quantity of subsets and a quantity of CMRs within each subset, and wherein the multiple CMR subset pre-groupings are indicated in the CSI resource setting associated with the CSI report.

28. The apparatus of claim 24, wherein the quantized CMR-common L1-RSRP/SINR measurement is based at least in part on a quantization metric, and wherein the quantization metric is based at least in part on one or more of: a standard predefinition, a network node pre-configuration, a dynamic indication from the network node, or a UE report.

29. The apparatus of claim 24, wherein the quantized CMR-common L1-RSRP/SINR measurement is differentially quantized with respect to the explicit L1-RSRP/SINR measurement, wherein the explicit L1-RSRP/SINR measurement is a strongest explicit L1-RSRP/SINR measurement or a weakest explicit L1-RSRP/SINR measurement of K explicit L1-RSRP/SINR measurements, and wherein a quantity of bits associated with the quantized CMR-common L1-RSRP/SINR measurement is greater than a quantity of bits associated with the explicit L1-RSRP/SINR measurement.

30. The apparatus of claim 24, wherein the one or more processors are further configured to:
receive, from the UE, an indication of a subset identifier associated with a strongest quantized CMR-common L1-RSRP/SINR measurement of multiple quantized CMR-common L1-RSRP/SINR measurements associated with respective CMR subsets.
